(19) United States
(12) Patent Application Publication
(10) Pub. No.: US 2025/0001542 A1
(43) Pub. Date: Jan. 2, 2025

(54) METHOD FOR POLISHING A SUBSTRATE

(71) Applicant: ILLUMINA, INC., San Diego, CA (US)

(72) Inventors: Alisina BAZRAFSHAN, San Diego, CA (US); Justin FULLERTON, San Diego, CA (US); Avishek AIYAR, San Diego, CA (US); Maxwell ZIMMERLEY, San Diego, CA (US); Chandler BURKE, San Diego, CA (US); Arthur PITERA, San Diego, CA (US); Casey IRVIN, San Diego, CA (US); Tyler DILL, San Diego, CA (US)

(73) Assignee: ILLUMINA, INC., San Diego, CA (US)

(21) Appl. No.: 18/737,223

(22) Filed: Jun. 7, 2024

Related U.S. Application Data
(60) Provisional application No. 63/507,334, filed on Jun. 9, 2023.

(51) Int. Cl. B24B 7/13; B24B 37/10; B24B 57/02

(52) U.S. Cl. CPC B24B 7/13; B24B 37/10; B24B 57/02

(57) ABSTRACT

The present disclosure relates to methods, systems and compositions directed to unspooling a substrate from a source coil and polishing a surface of the substrate, wherein before the polishing, the substrate includes depressions separated by interstices and a coating including a hydrogel disposed on the depressions and the interstices, and the polishing includes applying a slurry to the surface of the substrate and removing the hydrogel from the interstices but not the depressions by contacting the surface of the substrate with one or more polisher and introducing relative movement between the one or more polisher and the surface.

### BACKGROUND

Flow cells as platforms for next generation gene sequencing apparatuses and methods may be produced using semiconductor manufacturing technology. The surface of a flow cell is normally fabricated using the following steps: (1) nanowells are initially etched into a uniform planar solid substrate such as glass; (2) nanowells and interstitial regions are functionalized with a silane and a polymer or hydrogel to which polynucleotides may subsequently be attached, and (3) excess polymer or hydrogel covering the interstitial regions is removed in a subtractive method known as chemical mechanical polishing (CMP) where the protruding hydrogel is removed from the interstitial regions abrasively leaving hydrogel in nanowells. DNA probes may be added to flow cell nanowell surfaces to capture prepared DNA strands for amplification during cluster generation. Interstitial regions, i.e. between nanowells, are devoid of DNA probes. The process promotes DNA clustering specifically within nanowells, providing even, consistent spacing between adjacent clusters and allowing accurate resolution of clusters during imaging. Maximal use of the flow cell surface leads to overall higher clustering. Patterned flow cells use distinct nanowells for cluster generation to make more efficient use of the flow cell surface area. Patterned flow cells may contain billions to tens of billions of nanowells at fixed locations across both surfaces of the flow cell. The structured organization provides even spacing of sequencing clusters to deliver significant advantages over non-patterned cluster generation. Clusters may form where probes have attached to the flowcell substrate, e.g. in nanowells with functionalized surfaces but not interstitial devoid of such functionalized surface, making the flow cells less susceptible to overloading, and more tolerant to a broader range of library densities. The present disclosure is directed to overcoming these and other deficiencies in the art.

### SUMMARY OF THE INVENTION

In an aspect, provided are methods including unspooling a substrate from a source coil and polishing a surface of the substrate, wherein before the polishing, the substrate includes depressions separated by interstices and a coating including a hydrogel disposed on the depressions and the interstices, and the polishing includes applying a slurry to the surface of the substrate and removing the hydrogel from the interstices but not the depressions by contacting the surface of the substrate with one or more polisher and introducing relative movement between the one or more polisher and the surface.

In an example, the polishing includes removing some of the hydrogel from the depressions. In another example, polishing includes removing substantially none of the hydrogel from the depressions.

In still another example, introducing relative movement between the one or more polisher relative to the surface of the substrate includes moving the substrate. In yet another example, introducing relative movement between the polisher relative to the surface of the substrate includes moving one or more of the one or more polisher.

In an example, the depressions are in one surface of the substrate. In another example, the depressions are in both surfaces of the substrate. In still another example, the substrate includes a first surface and a second surface, a front of the first surface and a front of the second surface includes the depressions, interstices, and coating, and a back of the first surface is laminated to a back of the second surface.

In an example the substrate further includes a protective film. Another example further includes disposing a protective film on the substrate. In a further example introducing relative movement includes moving a first section of the substrate at a first speed while moving a second section of the substrate at a second speed.

Another example further includes accumulating one or more length of the substrate before a first polishing, after a first polishing and before a second polishing, after the polishing, and any combination thereof. An example further includes accumulating the substrate with one or more accumulator. In another example, the accumulator includes one or more tensioner. In still another example, the accumulator includes one or more support. In yet another example, one or more accumulator retains the substrate at one or more tensions. In a further example, one or more accumulator retains one or more fixed lengths of the substrate. In still a further example, one or more accumulator retains one or more variable lengths of the substrate. In yet a further example, the substrate enters the one or more accumulator at a first speed and exits the one or more accumulator at a second speed wherein the first speed is either faster, slower or equal to the second speed.

An example further includes polishing a second surface. Another example further includes applying slurry to and polishing a second surface. In still another example, the polishing is to both surfaces.

In a further example, at least one of the one or more polisher includes at least one pad, and introducing relative movement between the at least one pad and the surface of the substrate includes rotating the at least one pad about a rotational axis, wherein the substrate extends along an x-axis and the rotational axis extends along a y-axis.

In still a further example, at least one pad includes two or more pads. In yet a further example, at least one pad is wider than the substrate. In an example, the width of at least one pad is substantially equal to or greater than the width of the substrate. In another example, at least one pad is narrower than the substrate. In still another example, at least one pad includes at least two pads of substantially equivalent widths. In yet another example, at least one pad includes at least two pads of different widths.

In a further example, at least one pad includes at least two pads narrower than the substrate and a combined width of the at least two pads are at least as wide as the substrate, and further including configuring a placement of the at least two pads such that, in combination, they contact a full width of the surface of the substrate during at least part of the polishing.

In still a further example, introducing relative movement includes displacing at least one pad along an x-axis. In yet a further example, introducing relative movement includes displacing the at least one pads along a z-axis.

In an example, applying the slurry includes dispensing the slurry from a dispenser attached to the at least one pad.

In another example, the at least one pad includes at least two pads and the introducing relative movement includes displacing one or more pad of the at least two pads along an x-axis and displacing one or more pad of the at least two pads along a z-axis.

In still another example, the at least one pad includes at least two pads having polishing grits that differ from each other.

In yet another example, the at least one pad includes at least two pads and the introducing relative movement includes displacing the at least two pads in different directions from each other. In a further example, the at least one pad includes at least two pads and the introducing relative movement includes displacing the at least two pads in substantially the same direction as each other.

In still a further example, the at least one pad includes at least three pads. In yet a further example, the at least one pad includes at least two pads having different rotational speeds from each other. In an example, the at least one pad includes at least two pads having different rotational directions from each other. In another example, the introducing relative movement includes changing a rotational speed of at the at least one pad during the polishing. In still another example, the introducing relative movement includes reversing a rotational spin of the at least one pad during the polishing.

In yet another example, the at least one pad includes at least two pads and the at least two pads remove the hydrogel at different rates from each other. In a further example, the at least one pad includes at least two pads and the at least two pads remove the hydrogel at the same rate as each other.

In still a further example, the at least one pad changes rotational direction or rotational speed one or more times during the polishing. In yet a further example, the at least one pad includes at least two pads, wherein a first slurry is applied where a first pad polishes the surface of the substrate and a second slurry is applied where a second pad polishes the surface of the substrate, and the first slurry is different from the second slurry.

In an example, at least one of the one or more polisher includes at least one roller, and the introducing relative movement between the polisher and the surface of the substrate includes rotating the at least one roller about a rotational axis, wherein the substrate extends along an x-axis and the rotational axis extends along a z-axis. In another example, the at least one roller includes two or more rollers. In still another example, the at least one roller is wider than the substrate. In yet another example, a width of the at least one roller is substantially equal to or greater than a width of the substrate. In a further example, the at least one roller is narrower than the substrate. In still a further example, the at least one roller includes at least two rollers of substantially equivalent widths. In yet a further example, the at least one roller includes at least two rollers of different widths.

In an example, the at least one roller includes at least two rollers narrower than the substrate and a combined widths of the at least two rollers is at least as wide as the substrate, and further includes configuring a placement of the at least two rollers such that in combination they contact a full width of the surface of the substrate during at least part of the polishing.

In another example, the introducing relative movement includes displacing the at least one roller along an x-axis. In still another example, the introducing relative movement includes displacing the at least one roller along a z-axis.

In yet another example, applying the slurry includes dispensing the slurry from a dispenser attached to the at least one roller. In a further example, the at least one roller includes at least two rollers and the introducing relative movement includes displacing one or more of the at least two rollers along an x-axis and displacing one or more of the at least two rollers along a z-axis. In a further example, the at least one roller includes at least two rollers having polishing grits that differ from each other. In yet a further example, the at least one roller includes at least two rollers and the introducing relative movement includes displacing the at least two rollers in different directions from each other. In an example, the at least one roller includes at least two rollers and the introducing relative movement includes displacing the at least two rollers in substantially the same direction as each other. In another example, the at least one roller includes at least three rollers.

In still another example, the at least one roller includes at least two rollers having different rotational speeds from each other. In yet another example, the at least one roller includes at least two rollers having different rotational directions from each other. In a further example, the introducing relative movement includes changing a rotational speed of the at least one roller during the polishing. In still a further example, the introducing relative movement includes reversing a rotational spin of the at least one roller during the polishing. In yet a further example, the at least one roller includes at least two rollers and the at least two rollers remove the hydrogel at different rates from each other. In an example, the at least one roller includes at least two rollers and the at least two rollers remove the hydrogel at the same rates as each other.

In another example, the at least one roller changes rotational direction or rotational speed one or more times during the polishing. In still another example, the at least one roller includes at least two rollers, wherein a first slurry is applied where a first roller polishes the surface of the substrate and a second slurry is applied where a second roller polishes the surface of the substrate, and the first slurry is different from the second slurry.

Yet another example further includes supporting a surface of the substrate that is not polished with at least one cylindrical support. In a further example, the at least one cylindrical support is a same width or wider than the width of the substrate. In still a further example, the at least one cylindrical support includes two or more cylindrical supports. In yet a further example, the at least one cylindrical support includes at least two cylindrical supports narrower than the substrate and a combined widths of the at least two cylindrical supports is at least as wide as the substrate, and further includes configuring a placement of the at least two cylindrical supports such that in combination they contact a full width of the surface of the substrate during at least part of the polishing.

In an example, at least one of the one or more polisher includes at least one belt, and the introducing relative movement between the polisher and the surface of the substrate includes moving a surface of the belt contacting the surface of the substrate. In another example, the at least one belt includes two or more belts. In still another example, the at least one belt is wider than the substrate. In yet another example, a width of the at least one belt is substantially equal to or greater than a width of the substrate. In a further example, the at least one belt is narrower than the substrate. In still a further example, the at least one belt includes at least two belts of substantially equivalent widths. In yet a further example, the at least one belt includes at least two belts of different widths. In an example, the at least one belt includes at least two belts narrower than the substrate and a combined widths of the at least two belts is at least as wide as the substrate, and further including configuring a placement of the at least two belts such that in combination they contact a full width of the surface of the substrate during at least part of the polishing.

In another example, the introducing relative movement includes displacing the at least one belt along an x-axis. In still another example, the introducing relative movement includes displacing the at least one belts along a z-axis. In yet another example, applying the slurry includes dispensing the slurry from a dispenser attached to the at least one belt. In a further example, the at least one belt includes at least two belts and the introducing relative movement includes displacing one or more of the at least two belts along an x-axis and displacing one or more of the at least two belts along a z-axis. In still a further example, the at least one belt includes at least two belts having polishing grits that differ from each other.

In yet a further example, the at least one belt includes at least two belts and the introducing relative movement includes displacing the at least two belts in different directions from each other. In an example, the at least one belt includes at least two belts and the introducing relative movement includes displacing the at least two belts in substantially the same direction as each other.

In another example, the at least one belt includes at least three belts. In still another example, the at least one belt includes at least two belts having different rotational speeds from each other. In yet another example, the at least one belt includes at least two belts having different rotational directions from each other. In a further example, the introducing relative movement includes changing a rotational speed of the at least one belt during the polishing. In still a further example, the introducing relative movement includes reversing a rotational spin of the at least one belt during the polishing.

In yet a further example, the at least one belt includes at least two belts and the at least two belts remove the hydrogel at different rates from each other. In an example, the at least one belt includes at least two belts and the at least two belts remove the hydrogel at the same rate as each other.

In another example, the at least one belt includes at least two belts and wherein one or more of the at least two belts change a rotational direction or a rotational speed one or more times during the polishing. In still another example, the at least one belt includes at least two belts, wherein a first slurry is applied where a first belt polishes the surface of the substrate and a second slurry is applied where a second belt polishes the surface of the substrate, and the first slurry is different from the second slurry. Yet another example further includes moving the at least one belt includes spinning the belt around two or more rollers.

In a further example, the one or more polisher is one or more pad, one or more roller, one or more belt or any combination thereof. In still a further example, at least one of the one or more polisher is flexible. In yet a further example, at least one of the one or more polisher is rigid. In an example, the one or more polisher includes at least two polishers that use different slurries or different grit sizes.

In another example, one or more of the one or more polisher includes one or more blade. In still another example, the one or more blade includes two or more blades. In yet another example, the one or more blade is wider than the substrate. In a further example, a width of the one or more blade is substantially equal to or greater than a width of the substrate. In still a further example, the one or more blade is narrower than the substrate. In yet a further example, the one or more blade includes at least two blades of substantially equivalent widths. In an example, the one or more blade includes at least two blades of different widths. In another example, the one or more blade includes at least two blades narrower than the substrate and a combined width of the at least two blades is at least as wide as the substrate, and further including configuring a placement of the at least two blades such that, in combination, they contact a full width of the surface of the substrate during at least part of the polishing.

In still another example, the introducing relative movement includes displacing the one or more blade along an x-axis. In yet another example, the introducing relative movement includes displacing the one or more blade along a z-axis. In a further example the applying the slurry includes dispensing the slurry from a dispenser attached to the one or more blade. In still a further example, the one or more blade includes at least two blades and the introducing relative movement includes displacing one or more of the at least two blades along an x-axis and displacing one or more of the at least two blades along a z-axis. In yet a further example, the one or more blade includes at least two blades and the introducing relative movement includes displacing the at least two blades in different directions from each other. In an example the one or more blade includes at least two blades and the introducing relative movement includes displacing the at least two blades in substantially the same direction as each other.

In another example, the one or more blade includes at least three blades. In still another example, the one or more blade includes at least two blades and the at least two blades remove the hydrogel at different rates from each other. In yet another example, the one or more blade includes at least two blades and the at least two blades remove the hydrogel at the same rate as each other.

In a further example, the one or more blade includes at least two blades, wherein a first slurry is applied where a first blade polishes the surface of the substrate and a second slurry is applied where a second blade polishes the surface of the substrate, and the first slurry is different from the second slurry. In still a further example, the introducing relative movement between the one or more blade includes keeping the one or more blade stationary relative to the surface moving, wherein the surface is moving along an x-axis. In yet a further example, the one or more blade includes two or more blades configured at different angles relative to the substrate.

Another example further includes one or more of rinsing the surface of the substrate after the polishing, washing the surface of the substrate after the polishing, and drying the surface of the substrate after the polishing. Yet another example further includes respooling the substrate. An example further includes removing the protective film from a surface after another surface is polished.

Still another example further includes, after the unspooling the substrate and before the polishing disposing of the substrate onto a support surface. Yet another example further includes, after the unspooling the substrate and before the polishing disposing of the substrate onto a support surface including panels. A further example further includes, after the unspooling the substrate and before the polishing disposing of the substrate onto a support surface including panels separated by perforations. Still a further example further includes, after the unspooling the substrate and before the polishing disposing of the substrate onto a support surface including panels and dividing the panels.

Yet a further example further includes, after the unspooling the substrate and after the polishing disposing of the substrate onto a support surface. An example further includes, after the unspooling the substrate and after the polishing disposing of the substrate onto a support surface comprising panels. Another example further includes, after the unspooling the substrate and after the polishing disposing of the substrate onto a support surface including panels separated by perforations. Still another example further includes after the unspooling the substrate and after the polishing disposing of the substrate onto a support surface including panels and dividing the panels.

Yet another example includes more than one polishing. A further example includes one or both of more than one washing and more than one drying. Still a further example further includes, one or more cycle independently including a polishing followed by one or both of a washing and a drying. Yet a further example further includes one or more additional spooling step.

In an example, the slurry covers the surface of the substrate and is retained on the surface of the substrate. In another example, the slurry is retained on the surface of the substrate until it is washed or rinsed off the substrate. In still another example, the substrate includes a base layer and a laminate disposed on the base layer, wherein the surface of the substrate includes the laminate.

In another aspect, provided is a device for polishing a surface of a substrate including: a source coil from which the substrate is unspooled; the substrate includes depressions separated by interstices and a coating comprising hydrogel disposed on the depressions and the interstices; at least one supply line for applying a slurry to the surface of the substrate; and at least one polisher for removing the hydrogel from the interstices but not the depressions by contacting the surface of the substrate with the at least one polisher and introducing relative movement between the at least one polisher relative to the surface.

In a further example, the device includes at least one pad, and the introducing relative movement between the at least one polisher relative to the surface includes rotating the at least one pad about a rotational axis, wherein the substrate moves along an x-axis when contacting the at least one pad and the rotational axis extends along a y-axis.

In still a further example, the device includes at least one roller, and the introducing relative movement between the at least one polisher relative to the surface includes rotating the at least one roller about a rotational axis, wherein the substrate moves along an x-axis when contacting the at least one roller and the rotational axis extends along a z-axis.

In yet a further example, the device includes at least one belt, and the introducing relative movement between the at least one polisher relative to the surface includes moving a surface of the belt in contact with the surface of the substrate in a first direction, wherein the substrate moves in a second direction different from the first direction where it contacts the surface of the belt.

In an example, the device includes one or more blade, and the introducing relative movement between the at least one polisher relative to the surface includes moving the blade in a first direction, wherein the substrate moves in a second direction different from the first direction where it contacts the blade.

In another example, the device includes one or more blade, and the introducing relative movement between the at least one polisher relative to the surface includes keeping the blade stationary, wherein the substrate moves in a first direction relative to the blade.

In still another example, the device further includes the additional one or more device for rinsing the surface of the substrate, cleaning the surface of the substrate, and for drying the surface of the substrate. In yet another example, the device further includes a second coil for respooling the substrate. In a further example, the device further includes additional support to hold the substrate. In still a further example, the device further includes a trough wherein when the substrate is in the trough a desired slurry volume is maintained on the surface of the substrate. In yet a further example, the device further includes a device to monitor the polishing of the substrate. In an example the device further includes one or more polishers configured to polish both surfaces of the substrate. In another example, the device further includes an accumulator.

### BRIEF DESCRIPTION OF THE DRAWINGS

These and other features, aspects, and advantages of the present disclosure will become better understood when the following detailed description is read with reference to the accompanying drawings, wherein:

FIG. 1 shows a non-limiting example of a substrate with a flexible polymer coated with a resin layer with nanowells which are coated with hydrogel.

FIG. 2 shows a non-limiting example of methods of unspooling and polishing a substrate and a non-limiting device capable of said method.

FIG. 3 shows a non-limiting example of methods of unspooling, polishing and respooling a substrate and non-limiting devices capable of said method.

FIG. 4 shows a non-limiting example of polishing a substrate with two pads each configured with a slurry line.

FIG. 5 shows a non-limiting example of polishing a substrate with one pad substantially equal to the width of the substrate and polishing a substrate with two pads having a combined width at least as wide as the substrate.

FIG. 6 shows a non-limiting example of polishing a substrate using a slurry line and three rollers.

FIG. 7 shows non-limiting examples of an overhead view of polishing a substrate using three rollers.

FIG. 8 shows a non-limiting example of polishing a substrate using three rollers and supporting the surface of the substrate that is not polished with at least one cylindrical support.

FIG. 9 shows a non-limiting example of polishing a substrate using a belt that spins around rollers.

FIG. 10 shows a non-limiting example of an overhead view of polishing a substrate wing a belt where the belt moves in a direction opposing the direction of movement of the substrate.

FIG. 11 shows a non-limiting example of polishing a substrate using three blades.

FIG. 12 shows a non-limiting example of an overhead view polishing a substrate using three blades.

FIG. 13 shows a non-limiting example of a flow-chart describing polishing a substrate.

FIG. 14 shows a non-limiting example of a flow-chart describing polishing a substrate.

FIG. 15 shows a non-limiting example of a flow chart of roll to roll processing of a flow cell.

### DETAILED DESCRIPTION

Although the following text discloses a detailed description of implementations, examples and embodiments of methods, apparatuses, devices and/or articles of manufacture, it should be understood that the legal scope of the property right is defined by the words of the claims set forth at the end of this patent. Accordingly, the following detailed description is to be construed as examples only and does not describe every possible implementation. Numerous alternative implementations could be implemented, and it is envisioned that such alternative examples would still fall within the scope of the claims.

It should be understood that any material disclosed herein may be combined with any other material or materials disclosed herein whether or not combinations are explicitly disclosed herein. All examples and embodiments are intended to be non-limiting whether or not an example or embodiments specifically states it is non-limiting. For any method disclosed herein that includes discrete steps, the steps may be conducted in any feasible order including, as appropriate, any combination of two or more steps may be conducted simultaneously, and repeated steps and permutations of steps are included. Furthermore, the particular features, configurations, compositions, or characteristics may be combined in any suitable manner in one or more examples.

The disclosure relates to methods, systems, articles of manufacture and compositions useful for processing flow cells. Manufacturing flow cells according to a roll-to-roll manufacturing process as disclosed herein, using a substrate that may be spooled and unspooled during a manufacturing process or between stages of manufacturing, may reduce the overall cost of flow cell manufacturing. The reduced cost will be directly related to the increased affordability of next generation sequencing methods including in substrate processing such as lower material cost and higher production volume of finished goods.

Some of the processing techniques disclosed herein relate to roll-to-roll materials manufacturing. Roll-to-roll manufacturing involves continuous processing of a flexible substrate as it is conveyed along a processing line, from a first coil from which it is unspooled through one or more further processing steps. In an example, the substrate may be re-spooled, such as onto a second coil, after said one or more further processing steps. Roll-to-roll processing, or R2R, is also referred to as web processing or reel-to-reel processing. Roll-to-roll processing is a fabrication method used in manufacturing that embeds, coats, prints, polishes, cuts or laminates varying materials onto a rolled substrate material as that material is fed continuously from one source coil and may be optionally respooled on to a second coil. The roll-to-roll technique typically consists of at least one coil or roll containing the spooled or coiled substrate and one or more supports known as the web path, whereby the substrate or web material moves over supports and/or through these supports as one or more manufacturing steps occur. Roll-to-roll processing may apply additive, subtractive or material modification onto the substrate as it moves along the web path, belt-feed, or conveyor-based processes to create or produce a product, partially produce a product or to perform specific processing steps. A substrate may be derived from a web made of thin, flexible, and long material. The web materials may be stored or transported as rolls or coils at various stages of substrate processing. The substrate or web may consist of paper, metal foil, plastic films, textiles, metals, and even nanomaterials. R2R processing may include laminating, coating, printing, polishing, cutting, evaporation deposition, sputtering deposition, and chemical vapor deposition (CVD), gravure printing, flexographic printing, flatbed and rotary screen printing, imprint or soft lithography, offset printing, inject printing, roll coating, substrate masking, laser ablation or embedding other material on the substrate or web as the material moves from reel to reel, coil to coil or coil to finished or semi-finished product. Utilizing webs, instead of sheets of substrate, allows increases in efficiency of speed, scale and cost. Roll-to-roll processing may be continuous resulting in processing substrates at higher speed. Any steps of processing that may be performed using roll-to roll manufacturing will benefit from one or more gains of efficiency of manufacturing.

Roll to roll manufacturing of a flow cell substrate is described herein. Manufacturing a flow cell may include unspooling a substrate from a source coil and polishing the surface of the substrate. The process may begin with unspooling a length of substrate, the substrate having depressions, such as nanowells, separated by interstices and a coating of hydrogel disposed on the depressions and the interstices. Polishing the substrate may include applying a slurry to the surface of the substrate and removing the hydrogel from the interstices but not the depressions by contacting the surface of the substrate with one or more polisher and introducing relative movement between the one or more polisher and the surface. A slurry may be delivered from a slurry line and may have one or more abrasive particle or aggregates of particles of one or more sizes. Introducing relative movement between a polisher and the substrate may include rotating a polisher, unspooling a substrate contacting a stationary polisher and rotating a belt. A polisher may include one or more pad, roller, belt, blade and any combinations thereof. A substrate may be unspooled from a coil, polished and is then coiled onto a coil. A substrate may be unspooled from a coil and any of polishing with or without a slurry, washing, rinsing, drying, or combinations thereof, may be performed on the substrate and it may be recoiled on a coil. A polished substrate may be coiled on another coil to be further processed or disposed on a rigid substrate. The rigid substrate may provide rigid backing material to further process the polished substrate into a flow cell ready for applications such as nucleic acid sequencing.

Roll to roll manufacturing may make use of many types of substrates. Substrates may be composed of many types of materials. A substrate may include a film, resin, coating or any combination thereof. Disclosed are examples of materials useful for roll to roll manufacturing of a flow cell.

A roll to roll manufactured flow cell substrate may include one or more film. A film may include one or more material. A film may include one or more films. A film may be referred to as a layer. A film may include one or more coating. A film may include one or more resin. A resin may include one or more material. A resin may include on or more resin. A substrate may include one or more film, coating, layer, resin or any combination thereof.

A roll to roll manufactured flow cell substrate may include one or more coatings. A coating may be referred to as layer. A coating may be a top layer or film. A coating may be on top of a layer, film, resin or any combination thereof. A coating may include two or more coatings. A coating may include a hydrogel. A coating may include one or more hydrogels.

The substrate may include depressions separated by interstitial regions with a coating of hydrogel. A resin layer may include depression and interstitial regions with a coating of hydrogel. A film may include depressions and interstitial regions coated with a hydrogel. A hydrogel may include depressions and interstitial regions with a coating of hydrogel. The depressions may be referred to as nanowells, microwells or wells.

As used herein, the term “interstitial region”, “interstitial” and “interstices” refers to an area in a substrate or on a surface that separates other areas of the substrate or surface. The terms may be used interchangeably. For example, interstices or an interstitial region may separate one well (or concave feature) from another well (or concave feature) on a substrate, an array and a patterned surface. The two regions that are separated from each other may be discrete, lacking contact with each other. In another example, an interstitial region may separate a first portion of a feature from a second portion of a feature. In embodiments the interstices or interstitial region is continuous whereas the features are discrete, for example, as is the case for an array of wells in an otherwise continuous surface. The separation provided by an interstitial region may be partial or full separation. Interstitial regions may typically have a surface material that differs from the surface material of the features on the surface. For example, features of an array such as nanowells may have an amount or concentration of gel material or analytes that exceeds the amount or concentration present at the interstitial regions. In some embodiments the gel material or analytes may not be present at the interstitial regions.

Substrates, films, resins, layers webs and coatings may be patterned. Patterns include (e.g., stripes, swirls, lines, triangles, rectangles, circles, arcs, checks, plaids, diagonals, arrows, squares, crosshatches, trenches, posts, channels, channels connected to well, wells and nanowells, nanowells and interstitial regions). Any repeating shape or shapes may be a pattern. Patterns may be etched, printed, treated, sketched, cut, carved, engraved, imprinted, fixed, stamped, coated, embossed, embedded, or layered onto a substrate. The pattern may include one or more cleavage regions or modified regions on the substrate. patterned substrate may include, for example, wells etched into a substrate, resin or coating. The pattern of the etchings and geometry of the wells may take on a variety of different shapes and sizes. In an embodiment, wells are physically or functionally separable from each other. The pattern may be located on any region of the substrate. The pattern may be near the middle of the substrate. The pattern may be near the edges of the substrate. The pattern may be on the substrate except near the edges of the substrate. The edge of the substrate may provide gaps that lack patterns or nanowells and interstitial regions to allow polishing of the substrate surface to take place some distance from an edge. A distance from an edge may be about 1 cm, or about 2 cm, or about 3 cm, or about 4 cm, or about 5 cm, or about 6 cm, or about 7 cm, or about 8 cm or about 9 cm, or about 10 cm or about 10 to 15 cm, or about 15-20 cm.

As used herein, the term “flow cell” is intended to mean a vessel having a chamber (i.e., flow channel) where a reaction may be carried out, an inlet for delivering reagent(s) to the chamber, and an outlet for removing reagent(s) from the chamber. In some examples, the chamber enables the detection of the reaction that occurs in the chamber. For example, the chamber may include one or more transparent surfaces allowing for the optical detection of arrays, optically labeled molecules, or the like, in the chamber.

A lamination refers to the binding together of a film, a layer, a resin, a coating or any combination thereof.

As used herein, the term “polishing” is intended to mean mechanical or chemical treatment of a substrate, or a portion thereof, to remove a part of the substrate. Therefore, the term includes removing a coat of a substrate, including a coating of a layer of a substrate. Removal may be uniform or non-uniform. Mechanical polishing includes, for example, rubbing, chafing, smoothing, shaving, scraping, or otherwise treating a surface by the motion of applied pressure or other frictional forces as well as developing, finishing or refining the substrate to produce an altered surface of the substrate. The resultant surface is referred to herein as a “polished” surface. A direct polishing method may be used such that an abrasive surface contacts the surface to be polished or indirect polishing may be used such that a slurry or suspended aggregate is contacted with the surface in a lapping or polishing process. Specific examples of mechanical polishing include sanding, grinding or lapping. Chemical polishing methods may also be used such as treatment with acids such as hydrofluoric acid or bases such as sodium hydroxide. Other methods, well known in the art that may remove a part of a substrate, including a part of a layer of a substrate, also are included within the meaning of the term as it is used herein.

As used herein, “functionalized molecule” refers to a molecule comprising reactive moieties that may be used to attach to the surface of a substrate or one or more biomolecules by way of a chemical reaction or molecular interaction. Such attachment may be via a covalent bond or through other bonding or interactive forces. In some embodiments the molecular interaction may be specific binding between a ligand and receptor, pairs of which include, but are not limited to, streptavidin and biotin, a nucleic acid and its complement, an antibody and ligand, and others known in the art. For example, a functionalized molecule may be a hydrogel comprising one or more functional groups that are capable of reacting with or binding to a biomolecule of interest. A non-limiting specific example is PAZAM comprising one or more azide functional groups, which may react with oligonucleotides comprising alkyne groups. In some instances, a functionalized molecule is attached to the surface of a substrate with reactive site(s) left for further attachment with biomolecules of interests. In some other instances, a functionalized molecule is attached to the surface of a substrate with no reactive site left. Alternative examples include polymers/hydrogels with tetrazine functional groups, which may react with oligonucleotides comprising strained rings (such as cyclic alkene or cyclic alkyne groups, for example norbornene and BCN functional groups), or polymers/hydrogels with epoxy or glycidyl groups, which may react with oligonucleotides comprising amino or protected amino groups. Additional examples are disclosed in U.S. Ser. No. 62/073,764, which is hereby incorporated by reference in its entirety.

Optical transmissibility may include transmission of all wavelengths of light or a selected wavelength or wavelengths of light. Partial transmission of light may be included. Optical transmissibility may include partial light transmission, full light transmission, or degrees or percentages of light transmission that are deemed appropriate for a specific application. Optical transmission may include electromagnetic radiation wavelengths outside of the normal visible light spectrum. Examples outside the visible light range include UV, IR, EUV/VUV, very long wave infrared and millimeter wave. In an example optical transmissibility may include the optical transmission of light about 10 to 100 nm, or about 100 to 200 nm, or about 200 to 300 nm, or about 300 to 400 nm, or about 400 to 500 nm, or about 500 nm to 600 nm, or about 600 to 700 nm, or about 700 to 800 nm, or about 800 to 900 nm, or about 900 to 1000 nm or about 1000 to 1100 nm, or about 1100 to 1200 nm, or about 1200 to 1300 nm, or about 1300 to 1400 nm, or about 1400 to 1500 nm, or about 1500 to 1600 nm, or about 1600 to 1700 nm, or about 1700 to 1800 nm, or about 1800 to 1900 nm, or about 1900 to 2000 nm. In an example, optical transmission may include one or more ranges of transmission.

A substrate includes a web, one or more layer, resin, coating, material, including optically transmissible materials, the substrate may be optically transmissible in one or more films, layers, coatings or resins. There may be one or more optically isolated materials, layers, coatings or resins. A top layer, coating, film, or any combination thereof may be optically isolated or optically transmissible. A depression, a well, or interstitial region may be optically transmissible or isolated as predetermined.

As used herein, the term “about” means that the numerical value is approximate and small variations would not significantly affect the practice of the disclosed embodiments. Where a numerical limitation is used, unless indicated otherwise by the context, “about” means the numerical value may vary by ±1 or ±10%, or any point therein, and remain within the scope of the disclosed embodiments.

A roll to roll manufactured flow cell substrate, for use in a manufacturing process as disclosed herein, may include one or more materials. A flow cell substrate may include a polymer film. A polymer film may include plastics, resins, adhesive, and combinations thereof. In an example a substrate includes an optically transmissive substrate including optically transmissive polymers, co-polymers and combinations thereof. Some non-limiting examples of materials include metal such as one or more of Fe, Ag, Au, Cu, Cr, Al, W, Mo, Zn, Ni, Pt, Pd, Co, In, Mn, Si, Ta, Ti, Sn, Zn, Pb, V, Ru, Ir, Zr, Rh, Mg, INVAR, steel, stainless steel (SUS), or an alloy of any combination thereof. Some non-limiting examples of materials useful for substrates include nylon, polyester, plastic film, metal foils, silicate glass, inorganic glass, borosilicate glass, phosphate glass, fused silica glass, modified or functionalized glass, quartz, sapphire, Corning Eagle 2000® (E2K) glass E2K, Corning Eagle XG® and Schott AF32®, alkali-free borosilicate glass, Vycor®, plastics (including acrylics, polystyrene and copolymers of styrene and other materials, polypropylene, polyethylene, polybutylene, polyurethanes, Teflon®, polyimides etc.), ceramics, resins, Zeonor®, silica or silica-based materials including silicon and modified silicon, carbon and optical fiber, optical fiber bundles or any combination thereof. Additional non-limiting examples include polymeric material such as polyimide (PI) or a copolymer comprising PI, polyacrylic acid or a copolymer comprising polyacrylic acid, polystyrene or a copolymer comprising polystyrene, polysulfate or a copolymer comprising polysulfate, polyamic acid or a copolymer comprising polyamic acid, polyamine or a copolymer comprising polyamine, polyvinylalcohol (PVA), polyallyamine, and any combination thereof. In further examples one or more materials include polyethylene terephthalate (PET), polyethylene naphthalate (PEN), polyarylate (PAR), polyetherimide (PEI), and polyether sulfone (PES), polyphenylene sulfide (PPS), polyamide (PA), polysulfone (PS), amorphous polyolefin (PO), polyamide-imide (PAI), liquid crystal polymer (LCP), modified polyphenylene ether (PPE), polybutylene terephthalate (PBT), polycarbonate (PC), and polyether ether ketone (PEEK), polyester (PET), polypropylene (PP), polyethylene (PE) film, polyvinyl chloride (PVC), cellulose acetate (CA), polyethylene terephthalate glycol (PETG), polymethyl methacrylate (PMMA), polyamide (PA6), polybutylene terephthalate (PBT), polyoxymethylene (POM), polyurethane (PU), ethylene vinyl acetate (EVA) or any combination thereof. Additional non-limiting examples may include organic conductive polymers including poly(acetylene) s, poly(pyrrole) s, poly(thiophene) s, polyanilines, polythiophenes, poly(p-phenylene sulfide), poly(p-phenylene vinylene) s (PPV), or any combinations thereof. Additional examples of non-limiting materials include one or more dielectric film layer comprising polyimides having a carboxylic ester structural unit in the polymer backbone, liquid crystal polymers and combinations thereof. Further non-limiting examples of materials include acrylonitrile butadiene styrene (ABS), acrylonitrile styrene acrylate (ASA), carbon black, Sabic® BR, Sabic® EPDM, Elvacite® and Lucite® acrylic resins or polymers or copolymers of methyl, ethyl or butyl methacrylate monomers, Rovene®, Ecronova®, Tykote®, BarrierPro®, Tylac®, Kapton®, cyclic olefin copolymer (COC), agarose, gelatin, hydrogels, acrylamide, polysaccharides, polydimethylsiloxane (PDMS; elastomer), high density polyethylene (HDPE), cyclic olefin polymers (COP), thiol-ene based resins or any combination thereof. Further non-limiting examples of materials include APS Resin Series® 1000-7000, phenolic, epoxy, alkyd, silicone, polyimine, fluoropolymers and any combination thereof.

Non-limiting examples of materials include non-swelling polycarbonate materials such as substituted and unsubstituted polycarbonates; polycarbonate blends such as polycarbonate/aliphatic polyester blends, including the blends of XYLEX®, polycarbonate/polyethyleneterephthalate (PC/PET) blends, polycarbonate/polybutyleneterephthalate (PC/PBT) blends, and polycarbonate/poly(ethylene 2,6-naphthalate) ((PPC/PBT, PC/PEN) blends, and any other blend of polycarbonate with a thermoplastic resin; and polycarbonate copolymers such as polycarbonate/polyethyleneterephthalate (PC/PET) and polycarbonate/polyetherimide (PC/PEI).

Non-limiting materials include optically transmissive materials such as polyethylene naphthalate (PEN), PET (polyethylene terephthalate, PEN (polyethylene naphthalate), HDPE (high density polyethylene, LDPE (low density polyethylene), LLDPE (linear low density polyethylene) or any combination thereof. Additional non-limiting examples include, optically transmissive materials include glass, fused-silica, polymethylmethacrylate (PMMA), polycarbonate (PC), cyclic olefin polymers (COP), or cyclic olefin copolymers (COC) or combinations thereof.

Non-limiting examples of materials include thermoplastic material such as polyolefins, polyesters, polyamides, poly(vinyl chloride), polyether esters, polyimides, polyesteramide, polyacrylates, polyvinylacetate, hydrolyzed derivatives of polyvinylacetate and combinations thereof. In an embodiment, polyolefins are preferred, particularly polyethylene or polypropylene, blends and/or copolymers thereof, and copolymers of propylene and/or ethylene with minor proportions of other monomers, such as vinyl acetate or acrylates such as methyl and butylacrylate. In an embodiment, polyolefins are preferred because of their excellent physical properties, ease of processing, and typically lower cost than other thermoplastic materials having similar characteristics. In an embodiment, polyolefins readily replicate the surface of a casting or embossing roll. In an embodiment, hydrophilic polyurethanes are also preferred for their physical properties and inherently high surface energy.

Non-limiting materials for substrates include resins such as acrylic-based resins derived from epoxies, polyesters, polyethers, and urethanes, ethylenically unsaturated compounds; aminoplast derivatives having at least one pendant acrylate group, polyurethanes (polyureas) derived from an isocyanate and a polyol (or polyamine), isocyanate derivatives having at least one pendant acrylate group, epoxy resins other than acrylated epoxies; and mixtures and combinations thereof. Additional non-limiting resins include polymers such as poly(carbonate), poly (methylmethacrylate), polyethylene terephthalate, aliphatic, polyurethane, and cross-linked acrylate such as mono- or multi-functional acrylates or acrylated epoxies, acrylated polyesters, and acrylated urethanes blended with mono- and multi-functional monomers or any combination thereof.

Non-limiting examples of resins include bisphenol A epoxy resin, bisphenol F epoxy resin, bisphenol S epoxy resin, brominated bisphenol A epoxy resin, hydrogenated bisphenol A epoxy resin, bisphenol AF epoxy resin, and biphenyl epoxy, naphthalene type epoxy resin, fluorene type epoxy resin, phenol novolak type epoxy resin, orthocresol novolak type epoxy resin, trishydroxyphenylmethane type epoxy resin, tetraphenylolethane type epoxy resin, hydantoin type epoxy resin, trisglycidyl isocyanurate type epoxy resin and glycidylamine type epoxy resin or any combination thereof.

Non-limiting examples of materials include photocurable resin such as acrylic resin or an alkyd resin into which a polymerizable unsaturated group has been introduced, an unsaturated polyester resin, such as polyimide, polyamide, polyetheretherketone, polyester and combinations thereof.

Non-limiting examples of materials include adhesive such as epoxy, acrylic, pressure sensitive, cyanoacrylate, polyurethane, silicone and any combination thereof.

Non-limiting examples of materials include thermosetting solid adhesives including EPON® 1001F, R1500, and Scotch-Weld9®, structural adhesive film AF 191 from 3M®, cyanoacrylates, polyester, urea-formaldehyde, melamine-formaldehyde, resorcinol, rescorsinol-phenol-formaldehyde, epoxy, polyimide, polybenzimidazole, acrylics, acrylic acid diester compounds and combinations thereof.

Non-limiting materials include thermoplastic resin such as polyester, polyamide, polyimide, polyether imide, polyamide imide, polycarbonate, modified polyphenylene ether, polyacetal, polyarylate, polysulfone, polyether sulfone, polyphenylene sulfide, polyether ether ketone, liquid crystal polymer, vinylidene resin, polybenzimidazole, polybenzoxazole and combinations thereof.

Non-limiting examples of materials include heat-resistant resin containing a thermosetting accelerator such as aliphatic amines, aromatic amines, polyamide resins, secondary or tertiary amines, imidazoles, liquid polymercaptans, polysulfide resins, acid anhydrides, boron-amine complexes, dicyanamides, organic acid hydrazides, peroxides combinations thereof.

Non-limiting examples of materials include includes affinity resins such as protein A, protein G, nickel, titanium, iron, antibody coated resins or any combination thereof.

Non-limiting examples of materials include rubbers such as natural rubber, silicone rubber, acrylic rubber, urethane rubber, butadiene rubber, chloroprene rubber, isoprene rubber, nitrile rubber, epichlorohydrin rubber, butyl rubber, fluororubber, acrylonitrile-butadiene rubber, ethylene-propylene rubber, styrene-butadiene rubber and combinations thereof.

Non-limiting examples of materials include synthetic rubber such as acrylonitrile-butadiene rubber; isoprene rubber, butyl rubber, polybutadiene rubber, ethylene-propylene rubber, urethane rubber, styrene-butadiene rubber, chloroprene rubber, acrylic rubber, epichlorohydrin rubber, fluororubber and combinations thereof. In embodiments where light transmittance may be desired, preferably used are acrylonitrile-butadiene rubber and/or polybutadiene rubber.

Non-limiting examples of materials include additives included to modify the property of one or more materials such as pigments to reduce optical transmission, static inhibitors, hydrophilic or hydrophobic material may be used to modify a material or a surface of a material.

A substrate for use in a roll to roll manufacturing process as disclosed herein may include a coating of one or more hydrogels. Hydrogel products constitute a group of polymeric materials, the hydrophilic structure of which renders them capable of holding large amounts of water in their three-dimensional networks. Hydrogel may be a water-swollen, and cross-linked polymeric network produced by the simple reaction of one or more monomers. Hydrogel may be formed by polymerization and parallel cross-linking of multifunctional monomers, as well as multiple step procedures involving synthesis of polymer molecules having reactive groups and their subsequent cross-linking. A crosslinker refers to a molecule that may form a three-dimensional network when reacted with the appropriate base monomers. Homopolymer hydrogels are a polymer network derived from a single species of monomer. Copolymeric hydrogels are comprised of two or more different monomer species with at least one hydrophilic component. Multipolymer Interpenetrating polymeric hydrogel (IPN) is made of two independent cross-linked synthetic and/or natural polymer component, contained in a network form. A hydrogel may be amorphous, semicrystalline, or crystalline in nature. A hydrogel may be ionic, nonionic, zwitterionic, or ampholytic. Hydrogel-forming natural polymers include proteins such as collagen and gelatin and polysaccharides such as starch, alginate, and agarose. Synthetic polymers that form hydrogels are traditionally prepared using chemical polymerization methods. Synthetic hydrogels include monomers such as acrylic acid (AA), acrylamide (AM), polyvinyl alcohol (PVA), polyethylene glycol (PEG), polyethylene oxide (PEO), poly(2-hydroxyethyl methacrylate) (PHEMA), 2-hydrocyethyl methacrylate (HEMA), polyacrylic acid (PAA), and polyacrylamide (PAAm). Hydrogels may include natural or synthetic polymers or combinations of both. As used herein, the terms monomers, co-monomers, copolymers and homopolymers may be referred to as polymers.

Chemical properties of hydrogels may be attained by incorporating specific polymers, co-monomers, and crosslinkers and by changing the crosslinking degree. A strong gel network may be obtained with increasing the degree of crosslinking. Crosslinking at high amounts may result in low elongation and elasticity with greater brittleness. An optimal degree of crosslinking for hydrogels is useful in order to retain the compromise between mechanical strength and elasticity. The hydrogel polymer may include about 0.1% to 10% of a crosslinker. The hydrogel polymer may include about 0.1 to 0.5, or about 0.5 to 1, or about 1-1.5, or about 1.5-2, or about 2-2.5, or about 2.5-3, or about 3-3.5, or about 3.5-4, or about 4-4.5, or about 4.5-5, or about 5-5.5, or about 5.5-6 or about 6-6.5, or about 6.5-7, or about 7-7.5, or about 7.5-8, or about 8-8.5, or about 8.5-9, or about 9-9.5, or about 9.5-10% crosslinker. The percentage of crosslinker may be expressed as weight to volume, volume to volume, or weight to weight.

In some examples, the pore size of the hydrogel is tuned by varying the ratio of the concentration of polymer to the concentration of crosslinker. In some examples, the ratio of polymer to crosslinker is about 30:1, about 25:1, about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:15, about 1:20, or about 1:30, or about any one of these rations, or a ratio within a range defined by any two of the aforementioned ratios. The ratio may be expressed as weight to volume, volume to volume, or weight to weight. In an example, a hydrogel may include multiple polymers each having a predetermined ratio of concentration of polymer to the concentration of crosslinker.

The density of cross-linking in the hydrogel may also be modified by adjusting the molecular weight of a monomer, polymer or co-monomer using an equivalent amount crosslinker. For instance Poly(ethylene glycol) dimethacrylate (PEGDM) at 2000 g/mol and 100,000 g/mol both crosslinked with the same amount crosslinker may have different crosslinking densities due to the size of the monomer. The smaller monomer may tend to have a higher crosslinked density. In some examples a monomer may be about 500 g/mol, or about 750 g/mol, or about 1000 g/mol, or about 1500 g/mol, or about 2000 g/mol, or about 2500 g/mol, or about 3000 g/mol, or about 4000 g/mol, or about 5000 g/mol, or about 6000 g/mol, or about 7000 g/mol, or about 8000 g/mol, or about 9000 g/mol, or about 10,000 g/mol, or about 20,000 g/mol or about 50,000 g/mol or about 100,000 g/mol or any combination thereof. Combinations of monomers with different molecular weights may be used to achieve the desired hydrogel properties. A combination of monomers, polymers or copolymers may use a predetermined percentage or ratio of crosslinker. In an example, each polymer, in a combination of polymers, uses a predetermined percentage or ratio of crosslinker.

To improve the mechanical properties of a hydrogel, it may be grafted on surface coated onto a stronger support. This technique involves the generation of free radicals onto a stronger support surface and then polymerizing monomers directly onto it as a result a chain of monomers are covalently bonded to the support. Irradiation of the substrate film or resin may generate free radicals useful for bonding hydrogel. Peroxide groups may be activated under the irradiation of ultraviolet lamps, which may initiate free radical polymerization of hydrogels on the surface of a substrate. The support may include the flow cell substrate as described herein. Modification of the substrate to improve hydrogel grafting may include any of the materials or modifications disclosed herein.

Additional hydrogel formulations are described herein. A hydrogel includes crosslinked polyacrylamide, an agarose gel, and crosslinked polyethylene glycol. Flow cells with hydrogel coating are described in U.S. Pat. No. 10,919,033B2 hereby incorporated in its entirety by reference. The hydrogel may be any hydrophilic polymer that serves as a coating, film, or layer of a substrate. The hydrogel remains on the flow cell substrate during nucleic acid sequencing. The hydrogel includes PAZAM (or variations thereof as described herein), crosslinked polyacrylamide, an agarose gel, crosslinked polyethylene glycol (PEG), or the like. The hydrogel may be other acrylamide based copolymers, agarose based copolymers, or PEG based copolymers. It is to be understood that an X-based copolymer (e.g., acrylamide based, agarose based, PEG based, etc.) includes the X component in an amount of about 10% or more of the molecular weight composition. The X-based copolymer includes about 10% of the molecular weight composition, or about 11% of the molecular weight composition, or about 12% of the molecular weight composition, or about 15% of the molecular weight composition, or about 20% of the molecular weight composition, or about 39% of the molecular weight composition, or about 45% of the molecular weight composition, or about 55% of the molecular weight composition, or about 60% of the molecular weight composition or a higher percentage of the X component. Moreover, the X component may be higher or lower than the given percentages, as long as the copolymer functions as a hydrogel. A crosslinked PEG hydrogel may be synthesized via covalent cross-linking of PEG macromers with reactive chain ends, such as acrylate, methacrylate, allyl ether, maleimide, vinyl sulfone, NHS ester and vinyl ether groups. Any of the example hydrogels may include hydrophobic or hydrophilic sidechains.

Hydrogel sheets suitable for sequencing reactions are disclosed in US20210402749A1 incorporated in its entirety herein by reference. Cationic polymer hydrogels are discussed in WO2021021515A1 incorporated in its entirety herein by reference. Non-limiting exemplary hydrogels that may be used in the present application include polyacrylamide, polymethacrylic acids, homopolymer hydrogels, copolymer hydrogels, multipolymer hydrogels and combinations thereof. WO 00/31148 (incorporated herein by reference) discloses polyacrylamide hydrogels and polyacrylamide hydrogel-based arrays in which a so-called polyacrylamide prepolymer is formed, preferably from acrylamide and an acrylic acid or an acrylic acid derivative containing a vinyl group. Crosslinking of the prepolymer may then be carried out. Functionalization of hydrogel may also be carried out. WO 01/01143 (incorporated herein by reference) describes technology similar to WO00/31148 but differing in that the hydrogel bears functionality capable of participating in a [2+2] photocycloaddition reaction with a biomolecule so as to form immobilized arrays of such biomolecules. Such functionalized hydrogels may be used in a method of composition of the present disclosure. Dimethylmaleimide (DMI) is a particularly preferred functionality. The use of [2+2] photocycloaddition reactions, in the context of polyacrylamide-based microarray technology is also described in WO02/12566 and WO03/014392 (both being incorporated herein by reference). U.S. Pat. No. 6,465,178 (incorporated herein by reference) discloses the use of reagent compositions in providing activated slides for use in preparing microarrays of nucleic acids; the reagent compositions include acrylamide copolymers. WO 00/53812 (incorporated herein by reference) discloses the preparation of polyacrylamide-based hydrogel arrays of DNA and the use of these arrays in amplification which may be used in a method or composition set forth herein. Once hydrogels have been formed, biomolecules may then be attached to them so as to produce molecular arrays, if desired. Attachment may be performed in different ways. For example, U.S. Pat. No. 6,372,813 (incorporated herein by reference) teaches immobilization of polynucleotides bearing dimethylmaleimide groups to the hydrogels produced which bear dimethylmaleimide groups by conducting a [2+2] photocycloaddition step between two dimethylmaleimide groups—one attached to the polynucleotide to be immobilized and one pendant from the hydrogel.

Hydrogel polymers include poly(N-(5-azidoacetamidylpentyl) acrylamide-co-acrylamide) (PAZAM). PAZAM may be prepared by polymerization of acrylamide and Azapa (N-(5-(2-azidoacetamido) pentyl) acrylamide) in any ratio. PAZAM may be a linear polymer. PAZAM may be lightly cross-linked polymer. The molecular weight of the PAZAM may range from about 10 kDa to about 1500 kDa. In an embodiment PAZAM may be about 312 kDa.

PAZAM may be applied as an aqueous solution. PAZAM may be applied as an aqueous solution with one or more solvent additives, such as ethanol. A method for preparation of different PAZAM polymers is discussed in detail in U.S. Pat. No. 9,012,022, which is hereby incorporated by reference in its entirety. PAZAM may be mixed with one or more polymers or hydrogels in the preparation of the polymer composition described herein. Non-limiting examples of hydrogel include PAZAM (or variations thereof as described herein), crosslinked polyacrylamide, an agarose gel, crosslinked polyethylene glycol (PEG), or the like. The hydrogel may include other acrylamide based copolymers, agarose based copolymers, or PEG based copolymers. In further examples a crosslinked PEG hydrogel may be synthesized via covalent cross-linking of PEG macromers with reactive chain ends, such as acrylate, methacrylate, allyl ether, maleimide, vinyl sulfone, NHS ester and vinyl ether groups. The hydrogel layer may be composed of any suitable polymers, such as silane-free acrylamide (SFA) polymer, methacrylamide, hydroxyethly methacrylate or N-vinyl pyrrolidinone. For example, two or more different species of acrylamide, methacrylamide, hydroxyethyl methacrylate, N-vinyl pyrolidinone or derivatives thereof may function as co-monomers that polymerize to form a copolymer hydrogel. Useful hydrogels include, but are not limited to, silane-free acrylamide (SFA) polymer (see US Pat. App. Pub. No. 2011/0059865 A1 incorporated herein in its entirety by reference), poly(N-(5-azidoacetamidylpentyl) acrylamide-co-acrylamide), polyacrylamide polymers formed from acrylamide and an acrylic acid or an acrylic acid containing a vinyl group as described, for example, in publication WO 00/31148 incorporated herein in its entirety by reference; polyacrylamide polymers formed from monomers that form [2+2] photo-cycloaddition reactions, for example, as described in publications WO 01/01143 or WO 03/014392 each incorporated in the entirety herein by reference; or polyacrylamide copolymers described in U.S. Pat. No. 6,465,178, WO 01/62982 or WO 00/53812 each incorporated herein in its entirety by reference. Chemically treated variants of these gel materials are also useful, such as chemically treated SFA made to react with oligonucleotides having a corresponding reactive group (such as the azidolysis of SFA to produce azido-SFA which is reactive with a 5′- or 3′-alkynyl modified oligonucleotides). Non-limiting examples of hydrogels and polymerizable materials that may be used to form hydrogels are described, for example, US Pat. App. Pub. No. 2011/0059865A1 incorporated herein in its entirety by reference. Other useful gels are those that are formed by a temperature dependent change in state from liquid to gelatinous. Examples include, but are not limited to agar, agarose, or gelatin. The hydrogel material that is in a well, depression or other concave feature on the surface of a structured substrate may be covalently attached to the surface. For example, PAZAM may be covalently attached to a surface using surface materials and other reagents set forth in U.S. Pat. No. 10,900,076B2 incorporated herein in its entirety by reference. However, the gel material need not be covalently attached to wells or depressions.

Non-limiting examples of hydrogels may be prepared by cross-linking hydrophilic biopolymers or synthetic polymers under appropriate conditions. Thus, in some examples, the hydrogel may include a crosslinker. Examples of polymers, which may include one or more crosslinkers, include but are not limited to, hyaluronans, chitosans, agar, heparin, sulfate, cellulose, alginates (including alginate sulfate), collagen, dextrans (including dextran sulfate), pectin, carrageenan, polylysine, gelatins (including gelatin type A), agarose, (meth)acrylate-oligolactide-PEO-oligolactide-meth) acrylate, PEO-PPO-PEO copolymers (Pluronics), poly(phosphazene), poly(methacrylates), poly(N-vinylpyrrolidone), PL(G)A-PEO-PL(G)A copolymers, poly(ethylene imine), polyethylene glycol (PEG)-thiol, PEG-acrylate, acrylamide, N,N′-bis(acryloyl) cystamine, PEG, polypropylene oxide (PPO), polyacrylic acid, poly(hydroxyethyl methacrylate) (PHEMA), poly(methyl methacrylate) (PMMA), poly(N-isopropylacrylamide) (PNIPAAm), poly(lactic acid) (PLA), poly(lactic-co-glycolic acid) (PLGA), polycaprolactone (PCL), poly(vinylsulfonic acid) (PVSA), poly(L-aspartic acid), poly(L-glutamic acid), bisacrylamide, diacrylate, diallylamine, triallylamine, divinyl sulfone, diethyleneglycol diallyl ether, ethyleneglycol diacrylate, polymethyleneglycol diacrylate, polyethyleneglycol diacrylate, trimethylopropoane trimethacrylate, ethoxylated trimethylol triacrylate, or ethoxylated pentaerythritol tetracrylate, or combinations or mixtures thereof. Thus, for example, a combination may include a polymer and a crosslinker, for example polyethylene glycol (PEG)-thiol/PEG-acrylate, acrylamide/N,N′-bis(acryloyl) cystamine (BACy), or PEG/polypropylene oxide (PPO).

Non-limiting examples of hydrogel includes silicone-hydrogels made by polymerizing the acrylate or methacrylate functionalized silicone monomer with hydrogel (hydrophilic) monomers, such as hydroxyethyl methacrylate (HEMA), N-Vinylpyrrolidone (NVP) and other monomers such as methyl methacrylic acid (MA), Dimethylacrylamide (DMA), etc, in the presence of crosslinker and free radical or photoinitiators. Crosslinking agents generally have two or more reactive functional groups at different sites of the molecule. Typically, these sites contain polymerizable ethylenic unsaturation groups. During curing, they form a covalent bond with two different polymer chains and form a stable three-dimensional network to improve the strength of the polymer. Crosslinking agents include ethylene glycol dimethacrylate and trimethyloylpropane trimethacrylate (about 0.1 to 2 wt %). Other useful crosslinking agents include diethyleneglycol dimethacrylate, bisphenol A dimethacrylate, diglycidyl bisphenol A dimethacrylate and dimethacrylate-terminated polyethylene glycol and reactive linear polyether modified silicones.

Roll to roll manufacturing of a substrate for use in flow cells may include a coiled substrate. In an embodiment the coiled substrate may contain depressions, such as patterned nanowells, and may include a functionalized substrate for polynucleotide attachment, such as hydrogel, disposed on the surface of the substrate, including on the interstices between the depressions and on or within the depression. Nanowells may be made in a substrate. A coiled substrate may include a resin disposed on a substrate and nanowells may be in the surface of the resin and a hydrogel may be disposed on the surface of the resin including on the interstices between the depressions and on or within the depression. A coiled substate may include a polymer film that may contain nanowells and interstitial regions with a hydrogel disposed on the surface of the polymer film, including on the interstices between the depressions and on or within the depression. A coiled substate may include a hydrogel that may contain nanowells and interstitial regions with a hydrogel disposed on the surface of the hydrogel, including on the interstices between the depressions and on or within the depression. A coiled substrate may include one or more hydrogel that may contain nanowells and interstitial regions with one or more hydrogel disposed on the surface of the hydrogel, including on the interstices between the depressions and on or within the depression.

A coiled substrate may have both a top and a bottom surface, the bottom being opposite the top. In an example one surface of a coiled substrate includes depressions and interstices wherein the hydrogel is disposed on the surface including on the interstices between the depressions and on or within the depressions. A coiled substrate may include depressions and interstices on both surfaces wherein the hydrogel is disposed on both surfaces including on the interstices between the depressions and on or within the depressions. In an example, a coiled substrate may include two substrates laminated together such that opposite surfaces have patterned depressions with a coating of hydrogel on the interstices and on and within the depressions. One or more substrates may be attached or laminated to one or more substrates such that they together form a coiled substrate and may be polished together. A coiled substrate may be divided into two or more coiled substrates before or after polishing. A coiled substrate may be a multilayer laminate such that both surfaces may include patterned depressions and interstices wherein the hydrogel is disposed on both surfaces including on the interstices between the depressions and on or within the depressions and both surfaces are polished. In an example a laminate substrate having two surfaces with depressions and interstices may be divided into two substrates after polishing both surfaces, each substrate with one surface including depressions and interstices and the other surface being relatively uniform without patterned depressions.

A coiled substrate may be laminated with a protective film before or after being unspooled but prior to polishing. A protective film may be applied to one or both surfaces of a coiled substrate. A protective film may be applied to a surface of a coiled substrate not being polished to protect the surface during polishing or other processing steps. A protective film may protect the optical transmission properties of the substrate by preventing scratches, abrasions, slurry contamination or other defects from occurring to the non-polished surface. A protective film may prevent the non-polished surface from contacting the slurry. A protective film may include plastics, resins, adhesives, or any combination of materials disclosed herein. A protective film may provide protection from mechanical forces, chemicals, abrasions, slurry compounds, solvents or combinations thereof. A protective film may improve the ability to of the protected surface to bond to a different surface after polishing and processing.

A process as disclosed herein may include unspooling a substrate from a coil. A coil may be referred to as a reel or spool on or around which a substrate is spooled, meaning wrapped or rolled up. A substrate may be unwound, uncoiled or unspooled from a coil. A substrate may be uncoiled from a spool and polished and then respooled onto the same coil. A substrate may be uncoiled and polished and coiled on one or more different coils. A coil may include a source coil. A coil may include a destination coil. A coil may include one or more auxiliary coil. A substrate may be spooled, unspooled or both before, after or during polishing, rinsing, drying, monitoring or any combination thereof.

Roll to roll manufacturing of a flow cell substrate may include supporting a surface of a substrate. A support may be continuous the entire length of the unspooled substrate. One or more support may contact the substrate. One or more support may contact one or more surfaces of the substrate. One or more supports may be different shapes and lengths. One or more support may be rectangular. One or more support may be cylindrical. One or more support may apply force to the substrate. One or more support may provide counter force when force may be applied by one or more polisher. A support may be of any shape, length, or width. One or more support may include flat, round, cylindrical, square, rectangular or polygonal supports. One or more support may be in an x-axis, y-axis, z-axis or combination thereof. One or more support may move with the substrate. One or more supports may impart movement into the substrate. One or more support may be made of one or more material or combinations of materials disclosed herein. One or more support may include one or more polisher. One or more support may include one or more coil. One or more support may include one or more slurry line. One or more support may include one or more device for washing, rinsing, drying, monitoring, spooling, unspooling, accumulating or combinations thereof.

One or more support may include one or more tensioners. One or more coil may include one or more tensioner. A tensioner may impart tension into the substrate. A tensioner may reduce deflection in the substate while force is applied by one or more polisher. Two or more tensioners may apply different amounts of tension. One or more tensioner may be positioned before, after, both before and after one or more polisher, device, coil, support, accumulator or combinations thereof. One or more tensioner may provide a variable amount of tension. One or more tensioner may provide a range of tension. One or more tensions may alter the tension in response to one or more polisher, accumulator, coil, device for washing, rinsing, drying, monitoring or combinations thereof. The tension may be measured in pounds per linear inch. The tension may be about 0 to 1 pounds per linear inch, or about 1 to 2 pounds per linear inch, or about 2 to 4 pounds per linear inch, or about 4 to 6 pounds per linear inch, or about 6 to 8 pounds per linear inch, or about 8 to 10 pounds per linear inch, or from about 10 to 20 pounds per linear inch, or from about 20 to 40 pounds per linear inch, or from about 40 to 80 pounds per linear inch, or from about 80 to 150 pounds per linear inches, or from about 150 to 200 pounds per linear inch, or from about greater than 200 pounds per linear inch or any combination thereof.

Roll to roll manufacturing of a flow cell substrate may utilize various forces applied to the substrate. A force may be applied to a substrate by a support, tensioner, forced air, forced fluid, vacuum, friction, one or more polisher or any combination thereof. One or more polisher may apply a force to the substrate during polishing. Two or more polishers may apply different forces to a substrate. One or more polisher may apply a different force depending on the abrasive, grit or particle size used in polishing. A force may be from about 0-1 pounds per square inch, or from about 1-2 pounds per square inch, or from about 2-3 pounds per square inch, or from about 3-4 pounds per square inch, or from about 4-5 pounds per square inch, or from about 5-6 pounds per square inch, or from about 6-7 pounds per square inch, or from about 7-8 pounds per square inch, or from about 8-9 pounds per square inch, or from about 9-10 pounds per square inch, or from about 10-15 pounds per square inch, or from about 15-20 pounds per square inch, or from about 20-25 pounds per square inch, or from about 25-30 pounds per square inch, or from about 30-35 pounds per square inch, or from about 35-40 pounds per square inch, or from about 40-45 pounds per square inch, or from about 45-50 pounds per square inch or from about more than 50 pounds per square inch.

Roll to roll manufacturing of a substrate for use in flow cells may include polishing.

Polishing may include buffing, sanding, grinding, scraping, shaving, slicing, cutting, with or without a slurry as disclosed herein. An example of polishing may include the removal of hydrogel from the surface of the interstices but not include removal of hydrogel from depressions or nanowells by one or more polisher. In another example removal of hydrogel may include removal from interstitial surfaces and partial removal of hydrogel from nanowells. Partial removal of hydrogel from polishing may leave a depression relative to an interstitial surface from which hydrogel has been removed, and/or removal from sides of a depression such as a nanowell, provided that at least some hydrogel remains covering a bottom surface of nanowells. Removal of hydrogel from nanowells as disclosed herein may not require removal of all hydrogel from nanowells and may include removal of some hydrogel from nanowells. Polishing may include polishing a region of a substrate such as all but the edges of the substrate. Polishing may include polishing just one half of the surface of a substrate. Polishing may include polishing a substrate that contains patterns of nanowells and interstices in a portion of the substrate and polishing only the patterned portion of the substrate or the entire substrate. Polishing a substrate includes polishing selected regions of the substrate. In an embodiment the edges of the substrate may not be polished. In some embodiments the entire surface of the substrate is polished. In embodiments, both sides of the coiled substrate are polished. In an example, a substrate is unspooled and a slurry is applied to one or more polishing pads configured to polish both sides of the substrate. In an example, a coiled substrate includes two substrates laminated together which are unspooled and both sides are polished. Polishing both sides of an unspooled substrate may happen simultaneously, continuously, discontinuously or combinations thereof. One or more polishers may be configured to oppose each other with the unspooled substrate sandwiched between the one or more polishers. In an example, the opposing one or more polishers apply and equal and opposing force onto the substrate. In another example, one or more polishers may polish one surface or one region of one surface of the substrate and then polish the other surface or one region of the other surface. One or more polishers may change position, location, axis of rotation, or combinations thereof to polish one or more surfaces of a substrate. One or more polisher may move in one or more x-axis, y-axis, z-axis or combinations thereof. One or more pads, rollers, belts, blades or combinations thereof may oppose each other to polish both surfaces. Polishing both sides of coiled substrate may occur after unspooling wherein one side is polished including any additional processing such as washing, rinsing, drying, monitoring, spooling, unspooling, accumulating or combinations thereof followed by polishing the other side including any additional processing such washing, rinsing, drying, monitoring, spooling, unspooling, accumulating or combinations thereof. In an example, after the surface of a coiled substrate is polished, including any additional washing, drying, rinsing, monitoring, spooling, unspooling, accumulating or combinations thereof, a protective film protecting the non-polished side is applied or removed. One or more polisher may polish for one or more fixed time periods, one or more variable time periods or combinations thereof. One or more polisher may stop or start polishing in response to one or more device for monitoring, washing, rinsing, drying, spooling, unspooling, accumulating or any combination thereof. One or more polisher, device for washing, rinsing, drying, spooling, unspooling, accumulating, monitoring, or combinations thereof may operate for one or more fixed timer period, variable time period or combinations thereof.

Roll to roll manufacturing of a substrate for use in flow cells may include polishing. One or more polisher may include one or more pads, rollers, belts, blades and any combination thereof. Any polishing surface disclosed herein as included in any type of polisher, including pad, roller, or belt, may also be included in a polishing surface of any other type of polisher disclosed herein. One or more polisher may be displaced in any of x-axis, y-axis, z-axis or any combination thereof whether polishing or not. Non-limiting examples of the movement of one or more polishers are given as examples. One or more polishers may move in any direction for polishing, rotating on an axis though not polishing, moving to a new location before or after polishing and any combination thereof.

Polishing may include one or more polisher. One or more polisher may include one or more pads, rollers, belts, blades and any combination thereof.

A polisher may include one or more pad. Non-limiting examples of one or more polishing pads, also referred to as polishing discs, may include wool pads, Scotch Brite® pads, foam pads, felt pads, polyester fiber pads, Dynabrade® pads, microfiber sponge, microfiber, sponge, cloth, Lumina® polish pads, 3M® polish pads, plastic foam pads, fiberglass, epoxy, rubber pads, wood fibers pads, plant fiber pads, ceramics pads, metal pads, paper, cloth, screen backed pads, gel polymer pads, steel wool pads, sand paper pads, stone pads, silicon carbide, aluminum oxide, iron oxide, cerium, chromium oxide, diamond, emery, or any combination thereof. In another example, polishing pads may include IC1000™, Ikonic™, Optivision™ Pro series, Politex™, Suba™ pads, 3M™ Trizact™, SUBA800, IC-1000, IC-1000/SUBA400, Surfin xxx-5, Surfin 000, SUBA800, Surfin xxx-5, Surfin 000 and combinations thereof.

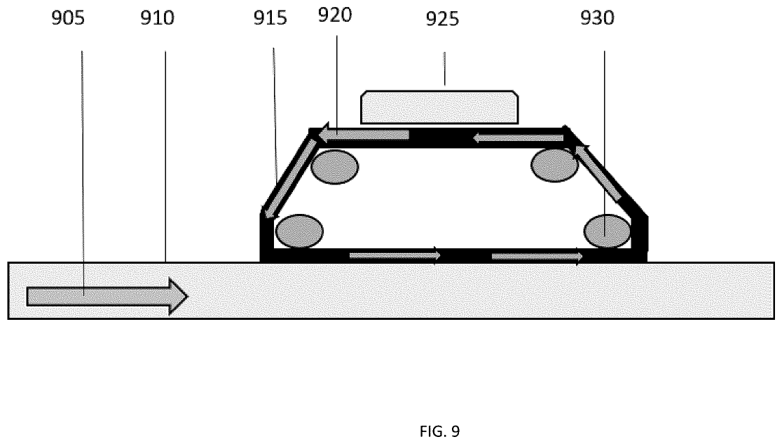

Polishers may be conditioned. Polishers may be conditioned while polishing. Polishers may be conditioned separately from the polishing. Non-limiting examples pad conditioners may include 3M™ Trizact™ Pad Conditioners and 3M™ Diamond Pad Conditioners. Polisher conditioning may be the introduction of new slurry material, removal of used slurry material or combinations thereof. A polisher may stop polishing and perform a conditioning step. A polisher may condition before or after polishing. A conditioning step may include a slurry composition without abrasive particles. Conditioning may include contacting one or more polisher on one or more support or with another one or more polisher and introducing relative movement. Conditioning may include contacting one or more polisher with one or more polisher one or more support while introducing a slurry or wash. A conditioning wash may include any of the wash solutions disclosed herein including water, water and detergent, water and disinfectants, water and alcohol, solvents, alcohols and combinations thereof. An example of conditioning a belt is depicted in FIG. 9, where a belt 915 may rotate around a series of rollers or wheels 930 and the belt 915 may be conditioned 925 as it rotates in a direction 920 and may contact a substrate 910 which may move in an opposite direction 905. In an example the belt in FIG. 9 may wrap around several sets of rollers 930 in a loop, wherein a portion of surface of the belt in one portion of the loop contacts the substrate surface 910 during polishing and another portion of the surface of the belt in another portion of the loop is conditioned 925. The belt may advance around the loop during the polishing or between one or more polishing, such that multiple portions of the surface of the belt contact the surface of the substrate during polishing, and receive conditioning, at different times. The conditioning may be continuous, discontinuous, for a period of time, during polishing, while polishing is stopped or paused or any combination thereof.

Polishing pads may be composed of any of the materials or combinations of materials disclosed herein. Polishing pads may use any abrasive, particles, materials or combination thereof disclosed herein. A polishing pad may use any combination of two or more abrasive materials disclosed herein. A polishing pad may use one or more grit, particle or aggregate particle sizes disclosed herein. A polishing pad may use any combination of two or more grit, particle or aggregate particle sizes disclosed herein.

One or more polisher may include one or more roller. Non-limiting examples of one or more roller may include a 3M® cartridge roller, 3M® vitrified grinding wheel or any combination thereof. One or more polishing roller may be of any material or combination disclosed herein. One or more polishing roller may use one or more abrasive material disclosed herein. One or more polishing roller may use any combination of two or more abrasive materials disclosed herein. One or more polishing roller may use one or more grit, particle or aggregate particle sizes disclosed herein. One or more polishing roller may use any combination of two or more grit, particle or aggregate particle sizes disclosed herein.

One or more polisher may include one or more belt. Non-limiting examples include a 3M® diamond polishing or lapping film, a 3M® aluminum oxide polishing or lapping film, 3M® cerium oxide polishing or lapping film and combinations thereof. One or more belt may include of any material or combination of materials disclosed herein. One or more belt may use one or more abrasive material disclosed herein. One or more belt may use any combination of two or more abrasive materials disclosed herein. One or more belt may use one or more grit, particle or aggregate particle sizes disclosed herein. One or more belt may use any combination of two or more grit, particle or aggregate particle sizes disclosed herein.

A polishing surface of one or more polisher may contain grooves for holding and replacing a slurry. The polishing surface of one or more polisher may be made of a foam having a large number of openings and thus has the function of holding and replacing a slurry. The polishing surface provided with grooves allows more efficient holding and replacing of a slurry and may prevent destruction of the polished substance, which is caused by adsorption on the polished substance. A polishing surface may contain one or more pores sizes. A pore size or combination of pore sizes may allow a particle or aggregate particle size to enter and exit while a larger particle or aggregate particle is trapped and may longer be used in the polishing process. In an embodiment polishing may be performed without any abrasive. For example, one or more polisher may be utilized with a slurry solution free of the abrasive particle (i.e., a slurry solution that does not include abrasive particles).

One or more polisher may include one or more blade. A polishing blade may be of any suitable material metal such a carbon steel, stainless steel, steel alloy, tool steel, ceramics, plastic, high density plastic or any suitable material disclosed herein. One or more blade may be configured to polish a surface of a substrate. Polishing a substrate may include scraping, slicing, shaving or cutting a surface, coating, film, layer, the substrate. One or more blade may be configured at various angles. The angle of blade configuration may determine the depth of polishing a surface. One or more blade angled nearly parallel to the substrate surface may remove a small amount of coating. One or more blade angled at 45 degrees to the surface may remove a larger amount of coating. One or more blades configured nearly parallel to the surface and another one or more blade angled at 45 degree to the surface may result in a progressive amount of coating being removed. One or more blade may be configured to polish in one direction while another one or more blade may be configured to polish from a different direction. One or more blade may be configured to about 0-10 degrees, or about 10-20 degrees, or about 20-30 degrees, or about 30-40 degrees, or about 40-50 degrees, or about 50-60 degrees, or about 60-70 degrees, or about 70-80 degrees, or about 80-90 degrees, or about 90-100 degrees, or about 100-110 degrees, or about 110-120 degrees, or about 120-130 degrees, or about 130-140 degrees, or about 140-150 degrees, or about 150-160 degrees, or about 160-170 degrees, or about 170-180 degrees to the surface.

Roll to roll manufacturing of a flow cell substrate may include one or more slurry lines. One or more Slurry lines may be before, after, inside, above, or under one or more polisher. Any combination of locations of slurry lines may be included in processing a substrate. One or more slurry line may be integrated into one or more polisher. One or more slurry line may be attached to one or more coil. One or more slurry line may be connected to one or more support. One or more slurry line may be connected to one or more device for rinsing, washing, or monitoring a substrate.

One or more Slurry lines may provide one or more slurries to a surface of a substrate for polishing. A one or more slurry line may provide one or more slurry to a surface of a substrate before polishing, during polishing, after polishing or combinations thereof. One or more slurry line may provide one or more slurry at a constant pressure. One or more slurry line may provide one or more slurry at variable pressures. One or more slurry line may provide the one or more slurry at a constant volume or a variable volume. One or more slurry lines may provide one or more slurry at specific time intervals. One or more slurry line may provide one or more slurry as a result of the activation of a polisher, a device, a spool or combinations thereof. One or more slurry line may provide one or more slurry as determined by one or more device monitoring the slurry, the polishing, the substrate, one or more polisher or combinations thereof. One or more slurry line may provide a continuous flow of one or more slurry while a substrate is being processed. One or more slurry line may provide one or more slurry to a polisher conditioner.

One or more slurry line may provide one or more slurry at a different volume, rate, pressure, temperature than another slurry line. One or more slurry line may provide one or more slurry at an equivalent volume, rate, pressure, temperature than another slurry line. One or more slurry line may be rinsed one or more times. One or more slurry line may be dried one or more times. One or more slurry lines may be rinses and dried one or more times. One or more slurry lines may be rinsed and dried one or more times between dispensing one or more slurry.

One or more slurry lines may be of any suitable material such as any of the materials or combination of material disclosed herein. A slurry line may be a plastic, glass, and metal tubing.

Roll to roll manufacturing of a flow cell substrate may include one or more rinsing and washing steps. Rinsing and washing may be used interchangeably. Alternatively, rinsing and washing may be used to indicate a different solution is being applied to achieve a different result. Washing and rinsing may include the use of water, ethanol, water-ethanol mixtures, benzyl alcohol, buffered water, acids, bases, solvents, alcohol, methanol, isopropyl alcohol, and combinations thereof. A wash and rinse solution may be supplied by one or more device. One or more device may be one or more nozzle, hoses, misters, spouts, jets or combinations thereof. A wash and rinse may be an alcohol, water or solvent and may be about 1-5%, or from about 5-10%, or from about 10-15%, or from about 15-20%, or from about 20-25%, or from about 25-30%, or from about 30-35%, or from about 35-40%, or from about 40-45%, or from about 45-50%, or from about 50-55%, or from about 55-60%, or from about 60-65%, or from about 65-70%, or from about 70-75%, or from about 75-80%, or from about 80-85%, or from about 85-90%, or from about 90-95% or from about 95-100%. Washing and rinsing may include multiple steps. Washing and rinsing may include multiple steps using different liquids or solutions. Washing and rinsing may occur before polishing, after polishing, during polishing and combinations thereof. Washing and rinsing may occur after each of one or more polishing steps.

Roll to roll manufacturing of a flow cell substrate may include one or more drying steps. Drying may include using heat for a source such as lamp, heater, blow dryer, blower or combinations thereof. The substrate may be dried under a vacuum. The substrate may be dried using forced air. The air may be of a specific velocity, temperature, humidity or volume. Drying may include heat from about 20-30 degrees centigrade, or from about 30-40 degrees centigrade, or from about 40-50 degrees centigrade, or from about 50-60 degrees centigrade, or from about 60-70 degrees centigrade, or from about 70-80 degrees centigrade, or from about 80-90 degrees centigrade, or from about 90-100 degrees centigrade, or from about over 100 degrees centigrade. Drying may include controlling the humidity air, forced air, a specific environment or combinations thereof. Humidity may be from about 0-5%, or from about 5-10%, or from about 10-15%, or from about 15-20%, or from about 20-25%, or from about 25-30%, or from about 30-35%, or from about 35-40%, or from about 40-45%, or from about 45-50%, or from about over 50% humidity.

Roll to roll manufacturing of a flow cell substrate may include monitoring a substrate. Monitoring a substrate may include measuring optical dyes on a surface, coating, layer, film or resin. Monitoring a substrate may include optical measurements of a coating, layer or surface. Monitoring a substrate may include monitoring an interference signal produced by the reflection of the light beam to detect the end point of polishing. Monitoring a substrate may include monitoring the change in light absorbance, reflection, transmission or combinations thereof. Monitoring a substrate may include monitoring the change in light absorbance, reflection or transmission in the depressions as compared to the interstitial regions. Light may reflect or be absorbed by the interstitial regions of a substrate and may be absorbed and not reflected by the depression when the hydrogel remains in the depression and not in the interstitial regions. The wavelength of light used to monitor the surface may be about 100-200 nanometers, or about 200-300 nanometers, or about 300-400 nanometers, or about 400-500 nanometers, or about 500-600 nanometers, or about 600-700 nanometers, or about 700-800 nanometers, or about 800-900 nanometers, or about 900-1000 nanometers, or about 1000-2000 nanometers, or about 2000-3000 nanometers.

Roll to roll manufacturing of a flow cell substrate may include a substrate being disposed onto one or more support. A support may include a support that is rigid. A support may include a perforated support. A perforated support may allow for a predetermined length of substrate to be separated and further processed into a complete flow device such as a flow cell. A support may include a support than may be divided. The substrate may be attached, fixed or placed on a more rigid support to produce a final product or a partially produced product. A solid support may include silica-based substrates, such as glass, fused silica, silicon, silicon dioxide, silicon nitride, or silicone hydrides, plastics, polyethylene, polystyrene, poly(vinyl chloride), polypropylene, nylons, polyesters, polycarbonates, cyclic olefin polymers, or poly(methyl methacrylate) or combinations thereof. A support may be optically transmissive or have regions that are optically transmissive and regions that are optically isolated. A support may be of any material or combination of materials disclosed herein.

Roll to roll manufacturing of a flow cell substrate may include movement of the substrate along an x-axis, y-axis or z-axis or combinations of these planes. The x-axis, y-axis and z-axis are given to provide the general, relative directions of movement and are not reflective of any objective orientation. The movement may be largely in a particular plane or axis which may be used to describe the overall direction the substrate, one or polisher or any object, liquid or gas moves but it may move in additional planes to achieve this overall motion. A person of skill in the art will understand that a substrate moving over a cylindrical substrate may not only move mostly along the x-axis as it is being processed but may also move in a y-axis to move up and over the cylindrical support. The indication of movement of a substrate, one or more polisher, one or more roller or any other object is not intended to be limiting to a specific axis where the general axis of movement is provided to describe an example.

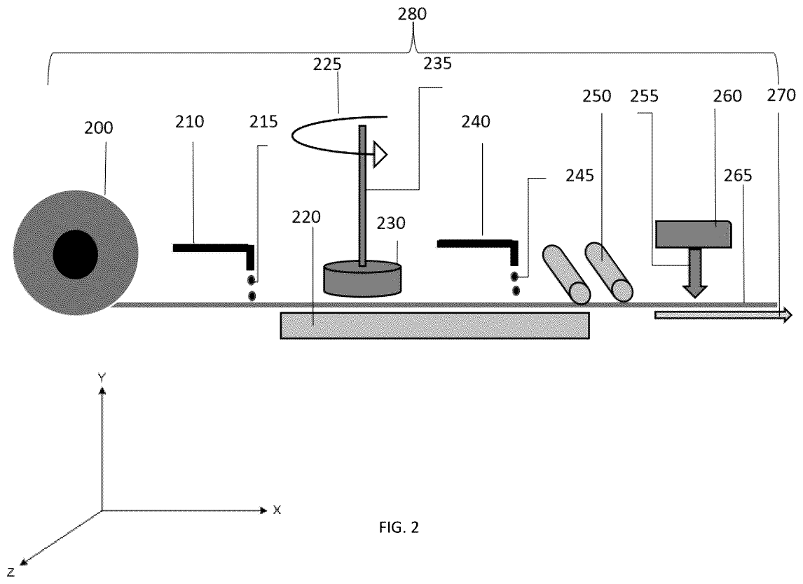

For example, an x-y-z axis is illustrated in FIG. 2. In reference thereto, as an example, a substrate may move from left to right, that is, along an x-plane. By moving along a plane, what is meant is that at least one aspect of a vector of a substrate's movement includes displacement along such plane. A substrate could also simultaneously or at another time also move by some degree along a z-plane, e.g., towards or away from the viewer viewing the example from the vantage point depicted in FIG. 2. Provided at least some of the displacement of the substrate is along an x plane, e.g., left-to-right as viewing the example depicted in FIG. 2, movement along an x plane is occurring, whether or not some displacement along a z-plane, e.g., towards or away from the viewer viewing the example as depicted in FIG. 2. Similarly, a polisher may rotate around an axis which extends along a plane. For example, a pad may contact a surface of the substrate, wherein the substrate may move along an x plane, whereas the pad may rotate 225 around an axis, wherein the axis extends along a y plane, generally perpendicular to the x plane, such as depicted in the x-y-z-axis in FIG. 2. By an axis extending along a plane, what is meant is that at least one aspect of a vector describing a direction of an axis leading away from a surface of the substrate includes a direction along such plane. An axis extending along a y plane could also simultaneously extend along a z-plane or x-plane to some degree, provided at least some of the direction of the axis traced away from the substrate is along a y plane, e.g., up-down as viewing the example depicted in FIG. 2, the axis extends along a y-plane.

In another example, a roller may contact a surface of the substrate, wherein the substrate may move along an x plane, whereas the roller may rotate around an axis wherein the axis extends along a z plane, perpendicular to the x plane, such as depicted in the x-y-z-axis in FIG. 2. An axis extending along a z-plane, or z-axis, could also simultaneously extend along a y- or x-plane to some degree. Provided at least some of the direction of the axis is along a z plane, e.g., towards or away from the viewer as viewing the example depicted in FIG. 2, the axis extends along a z-plane.

In another example, a belt may contact a surface of the substrate wherein the substrate may move along an x plane, or x-axis, whereas the belt may rotate around an axis wherein the axis extends along a z plane, or z-axis, perpendicular to the x plane as depicted in in FIG. 9, the belt though rotating about the z-axis may travel in a x-axis and y-axis to some degree during the rotation as depicted in FIG. 9.

The substrate may move at a fixed speed or at variable rates of speed. In some instances, the substrate may move at one or more speeds then pause and then continue at one or more speeds. The substrate may move at one or more speeds in one or more directions. The substrate may move in one or more x-axis, y-axis, z-axis or combinations thereof. The substrate may move along an x-axis at a first speed and then accumulate in a region and then continue along an x-axis at a second speed. In an example, a substrate may be unspooled move at a first faster speed and accumulate in a region and then continue to move at a second slower speed along an x-axis. The substrate may move at one or more speed for each one or more polisher, device or combinations thereof. The substrate may accumulate in regions to allow for differences in speed for one or more processing steps such as polishing, washing, rinsing, drying, monitoring, spooling, unspooling or combinations thereof. In an example, a predetermined length of substrate is allowed to accumulate between areas of processing, where processing includes polishing, washing, rinsing, drying, monitoring, spooling, unspooling and combinations thereof. The substrate may accumulate in a region or accumulate on a specific combination of supports called an accumulator. An accumulator may consist of supports such as rollers and tensioners to maintain a predetermined length of substrate available for processing at a first speed, second speed or any combination of speeds. One or more accumulators may be used with one or more polishers, coil, one or more device for washing, rinsing, drying or any combination thereof. An accumulator may allow one or more polisher to polish a first region of substrate moving at a first speed and a second one or more polisher to polish the first region of substrate at a second speed. A first speed may be equal to, slower or faster than a second speed. One or more accumulators may allow a substrate to move at one or more speeds. One or more accumulators may allow a substrate to move at one or more first and second speeds. An accumulator may allow the substrate to move at one or more variable speed, fixed speed or a combination thereof.

One or more accumulator may retain a substrate at one or more tensions. A first one or more supports, tensioners, or both in an accumulator may hold the substrate at a first tension and a second one or more supports, tensioners or both in an accumulator may hold the substrate at a second tension. One or more accumulator may retain a predetermined length of substrate without winding it on a coil. One or more accumulator may retain a predetermined length of substrate. One or more accumulator may retain a variable amount of substrate. One or more accumulator may retain a substrate at a variable tension. One or more accumulator may retain a substrate at a higher tension prior to the substrate moving at a slower speed. One or more accumulator may retain the substate at a lower tension prior to the substrate moving at a faster rate of speed. Alternatively, one or more accumulator may retain a substrate at a lower tension prior to the substrate moving at a slower rate of speed and at a higher tension prior to the substrate moving at a faster rate of speed.

Roll to roll manufacturing of a flow cell substrate may include the use of one or more slurry composition. One or more slurry composition may include one or more of the abrasive materials in one or more of the grit, particle or aggregate sizes disclosed herein. One or more slurry composition may include no abrasive materials. One or more slurry composition may include combinations of abrasive materials and combinations of grit, particle or aggregate sizes. One or more slurry composition may include one or more additives such as detergents, waxes, buffers, acids, bases, oils, solvents, thickeners, thinners, chelating agent, surfactants, cations, anions and dispersants. One or more slurry may be filtered to improve the particle or aggregate size uniformity and remove undesired particle or aggregate sizes. Filtering a slurry may occur in a slurry line. Filtering may occur in a reservoir that provides slurry. Filtering may be performed in a reservoir that captures slurry that contacted the substrate and one or more polisher. Filtering may be done with a filter, membrane, centrifugation, electric charge, magnetic attraction, ionic binding or combinations thereof.

Non-limiting examples of a slurry is described in U.S. Pat. No. 10,955,332B2 hereby incorporated by reference. Polishing the coating layer from the interstitial regions may use a basic, aqueous slurry having a pH having a pH ranging from about 7.5 to about 11 and including an abrasive particle having a hardness that is less than a hardness of the patterned substrate. In addition to the abrasive particles, the basic, aqueous slurry may also include a buffer, a chelating agent, a surfactant, and/or a dispersant. An example of a calcium carbonate slurry is described in U.S. Pat. No. 11,214,712B2 incorporated in its entirety herein by reference.

The slurry composition may contain additional materials. A slurry composition may contain an acid or base to improve or decrease abrasive particle or aggregate remove rates. Abrasive particles may remove materials in a pH dependent mechanism. Slurry additives may soften a coating or substrate to assist in polishing. A slurry may contain solutions to help solubilize material that is removed in polishing. A slurry may have a pH at about 0, or about 1, or about 2, or about 3, or about 4, or about 5, or about 6, or about 7, or about 8, or about 9, or about 10, or about 11, or about 12 or about 13, or about 14.

One or more slurries may be electrostatically stabilized in order to control the size distribution of the abrasive. By increasing the charge on the surface of the particles they repel each an inhibit particle agglomerates. The particles may be positively or negatively charged. The abrasive may be formulated to possess either negative or positive charge depending on the chemistries used. The zeta potential may be about 0-10 millivolts, or about 10-15 millivolts, or about 15-20 millivolts, or about 20-25 millivolts, or about 25-30 millivolts, or about 30-35 millivolts, or about 35-40 millivolts, or about 40-45 millivolts, or about 45-50 millivolts, or about 50-60 millivolts, or about 60-70 millivolts, or about 70-80 millivolts, or about 80-90 millivolts, or about 90-100 millivolts or 100-150 millivolts. The zeta potential may be about 0 to −10 millivolts, or about −10 to −15 millivolts, or about −15 to −20 millivolts, or about −20 to −25 millivolts, or about −25 to −30 millivolts, or about −30 to −35 millivolts, or about −35 to −40 millivolts, or about −40 to −45 millivolts, or about −45 to −50 millivolts, or about −50 to −60 millivolts, or about −60 to −70 millivolts, or about −70 to −80 millivolts, or about −80 to −90 millivolts, or about −90 to −100 millivolts or −100 to −150 millivolts.

The polishing grit may refer to the particle or aggregate particle size of the abrasive in angstroms. A particle or aggregate of particles may be about 1 angstroms, or from about 1-2 angstroms, or from about 2-3 angstroms, or from about 3-4 angstroms, or from about 4-5 angstroms, or from about 5-6 angstroms, or from about 5-7 angstroms, or from about 7-8 angstroms, or from about 8-9 angstroms, or from about 9-10 angstroms, or from about 10-15 angstroms, or from about 15-20 angstroms, or from about 20-25 angstroms, or from about 25-30 angstroms, or from about 30-35 angstroms, or from about 35-40 angstroms, or from about 40-45 angstroms, or from about 45-50 angstroms, or from about 50-55 angstroms, or from about 55-60 angstroms, or from about 60-65 angstroms, or from about 65-70 angstroms, or from about 70-75 angstroms, or from about 75-80 angstroms, or from about 80-85 angstroms, or from about 85-90 angstroms, or from about 90-95 angstroms, or from about 95-100 angstroms, or from about 100-125 angstroms, or from about 125-150 angstroms, or from about 150-175 angstroms, or from about 175-200 angstroms, or from about 200-225 angstroms, or from about 225-250 angstroms, or from about 250-275 angstroms, or from about 275-300 angstroms, or from about 300-325 angstroms, or from about 325-350 angstroms, or from about 350-375 angstroms, or from about 375-400 angstroms, or from about 400-425 angstroms, or from about 425-450 angstroms, or from about 450-475 angstroms, or from about 475-500 angstroms, or from about 500-600 angstroms, or from about 600-700 angstroms, or from about 700-800 angstroms, or from about 800-900 angstroms, or from about 900-1000 angstroms. In an example a silica abrasive particle size is larger than 300 Å, but filtration and post treatment enables to control the abrasive size below 150 Å.

The polishing grit may refer to the particle or aggregate particle size of the abrasive in nanometers. A particle or aggregate of particles may be about 1 nanometer, or from about 1-2 nanometers, or from about 2-3 nanometers, or from about 3-4 nanometers, or from about 4-5 nanometers, or from about 5-6 nanometers, or from about 5-7 nanometers, or from about 7-8 nanometers, or from about 8-9 nanometers, or from about 9-10 nanometers, or from about 10-15 nanometers, or from about 15-20 nanometers, or from about 20-25 nanometers, or from about 25-30 nanometers, or from about 30-35 nanometers, or from about 35-40 nanometers, or from about 40-45 nanometers, or from about 45-50 nanometers, or from about 50-55 nanometers, or from about 55-60 nanometers, or from about 60-65 nanometers, or from about 65-70 nanometers, or from about 70-75 nanometers, or from about 75-80 nanometers, or from about 80-85 nanometers, or from about 85-90 nanometers, or from about 90-95 nanometers, or from about 95-100 nanometers, or from about 100-125 nanometers, or from about 125-150 nanometers, or from about 150-175 nanometers, or from about 175-200 nanometers, or from about 200-225 nanometers, or from about 225-250 nanometers, or from about 250-275 nanometers, or from about 275-300 nanometers, or from about 300-325 nanometers, or from about 325-350 nanometers, or from about 350-375 nanometers, or from about 375-400 nanometers, or from about 400-425 nanometers, or from about 425-450 nanometers, or from about 450-475 nanometers, or from about 475-500 nanometers, or from about 500-600 nanometers, or from about 600-700 nanometers, or from about 700-800 nanometers, or from about 800-900 nanometers, or from about 900-1000 nanometers. The dispersed phase particles may have a diameter of approximately 1 nanometer to 1 micrometer. The typical size range of abrasive particles may be 50-250 nanometers. The typical oversize aggregate in slurry may be 1-10 microns. The typical size range of abrasive particles may be 10-250 nanometers.

The polishing grit may refer to the particle or aggregate particle size of the abrasive in micrometers. A particle or aggregate of particles may be about 1 micrometer, or from about 1-2 micrometers, or from about 2-3 micrometers, or from about 3-4 micrometers, or from about 4-5 micrometers, or from about 5-6 micrometers, or from about 5-7 micrometers, or from about 7-8 micrometers, or from about 8-9 micrometers, or from about 9-10 micrometers, or from about 10-15 micrometers, or from about 15-20 micrometers, or from about 20-25 micrometers, or from about 25-30 micrometers, or from about 30-35 micrometers, or from about 35-40 micrometers, or from about 40-45 micrometers, or from about 45-50 micrometers, or from about 50-55 micrometers, or from about 55-60 micrometers, or from about 60-65 micrometers, or from about 65-70 micrometers, or from about 70-75 micrometers, or from about 75-80 micrometers, or from about 80-85 micrometers, or from about 85-90 micrometers, or from about 90-95 micrometers, or from about 95-100 micrometers, or from about 100-125 micrometers, or from about 125-150 micrometers, or from about 150-175 micrometers, or from about 175-200 micrometers, or from about 200-225 micrometers, or from about 225-250 micrometers, or from about 250-275 micrometers, or from about 275-300 micrometers, or from about 300-325 micrometers, or from about 325-350 micrometers, or from about 350-375 micrometers, or from about 375-400 micrometers, or from about 400-425 micrometers, or from about 425-450 micrometers, or from about 450-475 micrometers, or from about 475-500 micrometers, or from about 500-600 micrometers, or from about 600-700 micrometers, or from about 700-800 micrometers, or from about 800-900 micrometers, or from about 900-1000 micrometers.

Non-limiting examples of polishing or abrasive materials may include ceramic, alumina, zirconia, aluminum oxide, silicon carbide, garnet, zirconium oxide, cerium oxide, trizact, natural minerals, synthetic minerals, calcium carbonate, corundum, emery (impure corundum), diamond dust (synthetic diamonds), novaculite, pumice, iron (III) oxide, sand, sandstone, rotten stone (Tripoli), powdered feldspar, staurolite Borazon (cubic boron nitride or CBN), ceramic, ceramic aluminum oxide, ceramic iron oxide, corundum (alumina or aluminum oxide), dry ice, glass powder, silica, silica beads, steel abrasive, silicon carbide (carborundum), zirconia alumina, boron carbide, diamond, corundum, emery, garnet, buhrstone, chert, quartz, garnet, emery, sandstone, chalcedony, flint, quartzite, silica, feldspar, natural crushed aluminum oxide, pumice, talc, boron carbide, cubic boron nitride, fused alumina, heat treated aluminum oxide (both brown and dark grey), fused alumina zirconia, glass, glass ceramics, iron oxides, tantalum carbide, chromia, tin oxide, titanium carbide, titanium diboride, manganese dioxide, zirconium oxide, sol gel alumina-based ceramics, silicon nitride, slags, beads, particles, aggregates or combinations thereof made from any material or combination of materials disclosed herein.

Non-limiting polishing or abrasive materials may include metal oxide, ceria (CeO2), calcined ceria, colloidal ceria, cerium hydroxide, silica (SiO2), alumina (Al2O3), titania (TiO2), zirconia (ZrO2), sodium silicate (Na2SiO3), sodium meta-silicate (NaHSiO3), fumed silica particles, colloidal silica and particles, aggregates or a combination thereof. A Slurry may consist of SiO2 or Al2O3 particles suspended in an acid or base solution at a concentration of 4% to 18% solids by weight. SiO2 slurries are referred to in the art as “oxide” slurries, and Al2O3 slurries are referred to as “metal” slurries. These slurries may rely on potassium hydroxide or ammonium hydroxide to effectively buffer the high pH. One or more slurry may consist of a concentration of solids by weight of 1%, or about 2%, or about 3%, or about 4%, or about 5%, or about 5%, or about 6%, or about 7%, or about 8%, or about 9%, or about 10%, or about 11%, or about 12%, or about 13%, or about 14%, or about 15%, or about 16%, or about 17%, or about 18%, or about 19%, or about 20%.

Non-limiting examples of commercially available slurries include Novaplane™, Optiplane™, Acuplane™ and Klebosol® slurries, PLANERLITE Series, COMPOL, GLANZOX, PLANERLITE series, Cerpol 27C, ZSL 200, ZSL300, AmberCut ASL 914SA.

The grit size of an abrasive particle or aggregate size is typically specified to be the longest dimension of the abrasive particle. There may be a range distribution of particle sizes. The particle or aggregate size distribution may be tightly controlled such that the resulting abrasive article provides a consistent surface finish. Particle or aggregate size may be, broad and/or polymodal particle size distributions may also be used. Filtering may be used to control particle size. Membranes with known pore sizes may be used to control particle size.

The abrasive particle or aggregate may also have a shape associated with it. Examples of such shapes include rods, triangles, pyramids, cones, solid spheres, hollow spheres and the like. Alternatively, the abrasive particle or aggregate may be randomly shaped and composite elements may take any useful form or shape, positive or negative, with preferred shapes including cylindrical, cubical, truncated cylindrical, prismatic, conical, facet shape, truncated conical, truncated pyramidal, cross, post like with flat top surface, hemispherical, flakes, crystals, and combinations of these shapes.

Abrasive particles or aggregates may be coated with materials to provide the particles with desired characteristics. For example, materials applied to the surface of an abrasive particle or aggregates have been shown to improve the adhesion between the abrasive and the substrate. A surface coating may alter and improve the cutting characteristics of the resulting abrasive particle. Some materials may assist in protecting a substrate or coating from abrasive particles or aggregates by softening the particles or shielding the substrate to reducing scratch depth. Some materials may assist in increasing scratch depth. Materials such as ionic compounds, anionic or cationic, may coat particles or aggregates to increase or decrease the attractive potential to a coating or substrate to control removal rates. An organic or inorganic cation or anion may be added as polishing booster or inhibitor. Ionic salts such as NaCl, LiCl, KCl and combinations thereof. The concentration of ionic salts may be about 0.1 M, to about 0.2 M, to about 0.3 M, to about 0.4 M, to about 0.5 M, to about 0.6 M, to about 0.7M, to about 0.8 M, to about 0.9 M, to about 1 M, to about 1.5 M, to about 2 M, to about 2.5 M.

The abrasive particles or aggregates may also contain other particles, e.g., filler particles, in combination with the abrasive particles. Examples of filler particles include carbonates (e.g., calcium carbonate), silicates (e.g., magnesium silicate, aluminum silicate, calcium silicate, and combinations thereof), and combinations thereof. Plastic filler particles may also be used. Proteins, amino acids, carbohydrates and combinations thereof may also be used. The filler particles may impart desirable characteristics to the abrasive particles or aggregates.

A polisher, one or more pad, roller or belt may include a bonded abrasive. A bonded abrasive may be composed of an abrasive material contained within a matrix. This matrix is called a binder and is often a clay, a resin, a glass or a rubber. This mixture of binder and abrasive is typically shaped into blocks, sticks, discs or wheels. The most common abrasive used is aluminum oxide. Also common are silicon carbide, tungsten carbide and garnet. The binder may be a polymeric material capable of containing the abrasive particles for use and may be prepared from one or more reactive chemistries. Binders may be prepared from polymerizable resins, as are known, such as organic polymer resins, e.g. thermoset resins. Examples of preferred resins include acrylate and methacrylate polymer resins. Another type of suitable binder is a ceramer binder that includes colloidal metal oxide particles in an organic polymer.

A flow cell substrate may contain one or more analytes. One or more analytes may be in a coating material that is present on a substrate. The gel-containing nanowells of the present disclosure are particularly useful for detection of analytes, or for carrying out synthetic reactions with analytes. Thus, any of a variety of analytes that may be detected, characterized, modified, synthesized, or the like may be present in or on gel material, such as one or more hydrogel as set forth herein. Exemplary analytes include, but are not limited to, nucleic acids (e.g. DNA, RNA or analogs thereof), proteins, polysaccharides, cells, antibodies, epitopes, receptors, ligands, enzymes (e.g. kinases, phosphatases or polymerases), small molecule drug candidates, or the like. A structured substrate may include multiple different species from a library of analytes. For example, the species may be different antibodies from an antibody library, nucleic acids having different sequences from a library of nucleic acids, proteins having different structure and/or function from a library of proteins, drug candidates from a combinatorial library of small molecules etc.

The depressions or nanowells may be about 1-10 nanometers deep, or from about 10-20 nanometers, or from about 20-30 nanometers, or from about 30-40 nanometers, or from about 40-50 nanometers, or from about 50-60 nanometers, or from about 60-70 nanometers, or from about 70-80 nanometers, or from about 80-90 nanometers, or from about 90-100 nanometers, or from about 100-125 nanometers, or from about 125-150 nanometers, or from about 150-175 nanometers, or from about 175-200 nanometers, or from about 200-225 nanometers, or from about 225-250 nanometers, or from about 250-275 nanometers, or from about 275-300 nanometers, or from about 300-325 nanometers, or from about 325-350 nanometers, or from about 350-375 nanometers, or from about 375-400 nanometers, or from about 400-425 nanometers, or from about 425-450 nanometers, or from about 450-475 nanometers, or from about 475-500 nanometers, or from about 500-600 nanometers, or from about 600-700 nanometers, or from about 700-800 nanometers, or from about 800-900 nanometers, or from about 900-1000 nanometers deep.

The depressions or nanowells may be about 1-10 micrometers deep, or from about 10-20 micrometers, or from about 20-30 micrometers, or from about 30-40 micrometers, or from about 40-50 micrometers, or from about 50-60 micrometers, or from about 60-70 micrometers, or from about 70-80 micrometers, or from about 80-90 micrometers, or from about 90-100 micrometers, or from about 100-125 micrometers, or from about 125-150 micrometers, or from about 150-175 micrometers, or from about 175-200 micrometers, or from about 200-225 micrometers, or from about 225-250 micrometers, or from about 250-275 micrometers, or from about 275-300 micrometers, or from about 300-325 micrometers, or from about 325-350 micrometers, or from about 350-375 micrometers, or from about 375-400 micrometers, or from about 400-425 micrometers, or from about 425-450 micrometers, or from about 450-475 micrometers, or from about 475-500 micrometers, or from about 500-600 micrometers, or from about 600-700 micrometers, or from about 700-800 micrometers, or from about 800-900 micrometers, or from about 900-1000 micrometers deep.

The nanowells may be about 1-10 nanometers wide, or from about 10-20 nanometers, or from about 20-30 nanometers, or from about 30-40 nanometers, or from about 40-50 nanometers, or from about 50-60 nanometers, or from about 60-70 nanometers, or from about 70-80 nanometers, or from about 80-90 nanometers, or from about 90-100 nanometers, or from about 100-125 nanometers, or from about 125-150 nanometers, or from about 150-175 nanometers, or from about 175-200 nanometers, or from about 200-225 nanometers, or from about 225-250 nanometers, or from about 250-275 nanometers, or from about 275-300 nanometers, or from about 300-325 nanometers, or from about 325-350 nanometers, or from about 350-375 nanometers, or from about 375-400 nanometers, or from about 400-425 nanometers, or from about 425-450 nanometers, or from about 450-475 nanometers, or from about 475-500 nanometers, or from about 500-600 nanometers, or from about 600-700 nanometers, or from about 700-800 nanometers, or from about 800-900 nanometers, or from about 900-1000 nanometers wide

The nanowells may about 1-10 micrometers wide, or from about 10-20 micrometers, or from about 20-30 micrometers, or from about 30-40 micrometers, or from about 40-50 micrometers, or from about 50-60 micrometers, or from about 60-70 micrometers, or from about 70-80 micrometers, or from about 80-90 micrometers, or from about 90-100 micrometers, or from about 100-125 micrometers, or from about 125-150 micrometers, or from about 150-175 micrometers, or from about 175-200 micrometers, or from about 200-225 micrometers, or from about 225-250 micrometers, or from about 250-275 micrometers, or from about 275-300 micrometers, or from about 300-325 micrometers, or from about 325-350 micrometers, or from about 350-375 micrometers, or from about 375-400 micrometers, or from about 400-425 micrometers, or from about 425-450 micrometers, or from about 450-475 micrometers, or from about 475-500 micrometers, or from about 500-600 micrometers, or from about 600-700 micrometers, or from about 700-800 micrometers, or from about 800-900 micrometers, or from about 900-1000 micrometers wide.

The interstitial regions between the nanowells may be 1-10 nanometers wide, or from about 10-20 nanometers, or from about 20-30 nanometers, or from about 30-40 nanometers, or from about 40-50 nanometers, or from about 50-60 nanometers, or from about 60-70 nanometers, or from about 70-80 nanometers, or from about 80-90 nanometers, or from about 90-100 nanometers, or from about 100-125 nanometers, or from about 125-150 nanometers, or from about 150-175 nanometers, or from about 175-200 nanometers, or from about 200-225 nanometers, or from about 225-250 nanometers, or from about 250-275 nanometers, or from about 275-300 nanometers, or from about 300-325 nanometers, or from about 325-350 nanometers, or from about 350-375 nanometers, or from about 375-400 nanometers, or from about 400-425 nanometers, or from about 425-450 nanometers, or from about 450-475 nanometers, or from about 475-500 nanometers, or from about 500-600 nanometers, or from about 600-700 nanometers, or from about 700-800 nanometers, or from about 800-900 nanometers, or from about 900-1000 nanometers wide

The interstitial regions between the nanowells may be about 1-10 micrometers wide, or from about 10-20 micrometers, or from about 20-30 micrometers, or from about 30-40 micrometers, or from about 40-50 micrometers, or from about 50-60 micrometers, or from about 60-70 micrometers, or from about 70-80 micrometers, or from about 80-90 micrometers, or from about 90-100 micrometers, or from about 100-125 micrometers, or from about 125-150 micrometers, or from about 150-175 micrometers, or from about 175-200 micrometers, or from about 200-225 micrometers, or from about 225-250 micrometers, or from about 250-275 micrometers, or from about 275-300 micrometers, or from about 300-325 micrometers, or from about 325-350 micrometers, or from about 350-375 micrometers, or from about 375-400 micrometers, or from about 400-425 micrometers, or from about 425-450 micrometers, or from about 450-475 micrometers, or from about 475-500 micrometers, or from about 500-600 micrometers, or from about 600-700 micrometers, or from about 700-800 micrometers, or from about 800-900 micrometers, or from about 900-1000 micrometers wide.

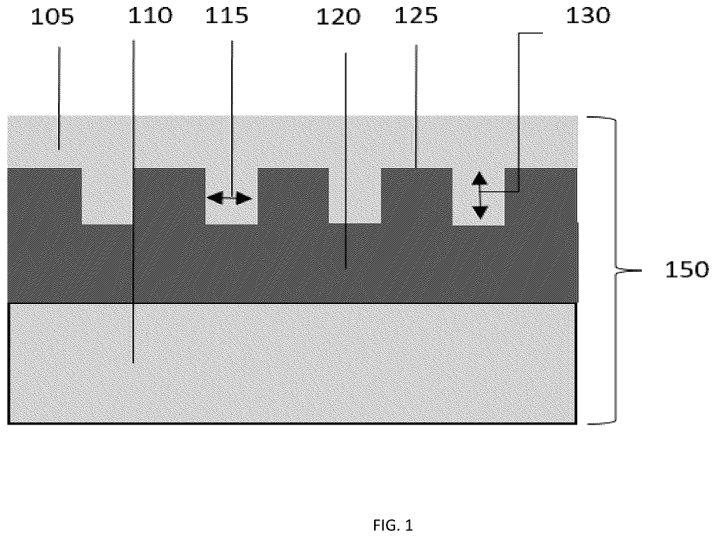

A substrate may be described by the thickness of the substrate itself. A substrate may have one or more layers that each have a specific thickness. A substrate may have one or more coating that may each have a specific thickness. An example is depicted in FIG. 1, where a flexible polymer layer 110 has a specific thickness, a resin layer 120 has a specific thickness and a hydrogel coating 105 has a specific thickness and the substrate 150 has a specific thickness. For example, in FIG. 1 the thickness of the resin layer 120 may be measured from the thickest or thinnest region. The hydrogel coating 105 in FIG. 1, for example, may be measured from the thickest or the thinnest region. In another example any layer may be measured from the thickest or thinnest region. In another example there may be a flexible polymer layer with a specific thickness and a hydrogel coating with a specific thickness. In another example there may be a hydrogel layer with a specific thickness and a hydrogel coat with a specific thickness. In another example a substrate may have a resin layer with a specific thickness with a coating of hydrogel with a specific thickness. In any of these examples the substrate may have depressions, or nanowells, separated by interstices with a hydrogel coating covering both the depressions and the interstices. A substrate, a coating, a film or a layer may have may have a thickness about be 1-10 nanometers thick, or from about 10-20 nanometers, or from about 20-30 nanometers, or from about 30-40 nanometers, or from about 40-50 nanometers, or from about 50-60 nanometers, or from about 60-70 nanometers, or from about 70-80 nanometers, or from about 80-90 nanometers, or from about 90-100 nanometers, or from about 100-125 nanometers, or from about 125-150 nanometers, or from about 150-175 nanometers, or from about 175-200 nanometers, or from about 200-225 nanometers, or from about 225-250 nanometers, or from about 250-275 nanometers, or from about 275-300 nanometers, or from about 300-325 nanometers, or from about 325-350 nanometers, or from about 350-375 nanometers, or from about 375-400 nanometers, or from about 400-425 nanometers, or from about 425-450 nanometers, or from about 450-475 nanometers, or from about 475-500 nanometers, or from about 500-600 nanometers, or from about 600-700 nanometers, or from about 700-800 nanometers, or from about 800-900 nanometers, or from about 900-1000 nanometers thick.

A substrate, a coating, a film or a layer may have a thickness of about 1-10 micrometers thick, or from about 10-20 micrometers, or from about 20-30 micrometers, or from about 30-40 micrometers, or from about 40-50 micrometers, or from about 50-60 micrometers, or from about 60-70 micrometers, or from about 70-80 micrometers, or from about 80-90 micrometers, or from about 90-100 micrometers, or from about 100-125 micrometers, or from about 125-150 micrometers, or from about 150-175 micrometers, or from about 175-200 micrometers, or from about 200-225 micrometers, or from about 225-250 micrometers, or from about 250-275 micrometers, or from about 275-300 micrometers, or from about 300-325 micrometers, or from about 325-350 micrometers, or from about 350-375 micrometers, or from about 375-400 micrometers, or from about 400-425 micrometers, or from about 425-450 micrometers, or from about 450-475 micrometers, or from about 475-500 micrometers, or from about 500-600 micrometers, or from about 600-700 micrometers, or from about 700-800 micrometers, or from about 800-900 micrometers, or from about 900-1000 micrometers wide In an example, a coating, film, layer, or resin is has a thickness of about 1-10, or from about 10-20, or from about 20-30, or from about 30-40, or from about 40-50, or from about 50-60, or from about 60-70, or from about 70-80, or from about 80-90, or from about 90-100, or from about 100-125, or from about 125-150, or from about 150-175, or from about 175-200, or from about 200-225, or from about 225-250, or from about 250-275, or from about 275-300, or from about 300-325, or from about 325-350, or from about 350-375, or from about 375-400, or from about 400-425, or from about 425-450, or from about 450-475, or from about 475-500, or from about 500-600, or from about 600-700, or from about 700-800, or from about 800-900, or from about 900-1000 millimeters thick.

A substrate, a coating, a film or a layer may have a thickness of about 1 millimeter, or about 2 millimeter, or about 3 millimeter, or about 4 millimeter or about 5 millimeters, or about 6 millimeters, or about 7 millimeters, or about 8 millimeters, or about 9 millimeters, or about 10 millimeters thick.

A length of substrate may be polished, accumulated, spooled, unspooled, washed, rinsed, dried, monitored or combinations thereof. A length of substrate may be about 10 cm, or about 20 cm, or about 30 cm or about 40 cm, or about 50 cm, or about 60 cm, or about 70 cm, or about 80 cm, or about 90 cm, or about 100 cm, or about 125 cm, or about 150 cm, or about 175 cm, or about 200 cm, or about 250 cm, or about 300 cm, or about 350 cm, or about 400 cm, or about 500 cm, or about 1 m, or about 2 m, or about 3 m, or about 4 m, or about 5 m, or about 6 m, or about 7 m, or about 8 m, or about 9 m, or about 10 m, or about 20 m.

Examples of hydrogel coatings on a substrate such as a flow cell are described in U.S. Pat. No. 10,919,033B2 incorporated herein in its entirety by reference. Gel patterned surfaces are described in application US20140243224A1 incorporated herein in its entirety by reference. Polymer coating are described in application US20170342487A1 incorporated herein in its entirety by reference. Methods of localizing nucleic acids to arrays are discussed in U.S. Pat. No. 9,376,710B2 incorporated herein in its entirety by reference. Hydrogel for sequencing applications is discussed in U.S. Pat. No. 9,498,763B2 incorporated herein in its entirety by reference. Additional details of planar solid substrate flow cells can be found in publication WO2014133905A1 hereby incorporated in its entirety by reference.

Methods of nucleic acid detection and hydrogel formulations are discussed in US20140378323A1 incorporated herein in its entirety by reference. Hydrogel polymers are also discussed in US20190352327 incorporated herein in its entirety by reference. Hydrogels and branching hydrogels are discussed in US2022185927A1 incorporated herein in its entirety by reference. Hydrogel in flow cells is discussed in WO2023278739A1 incorporated herein in its entirety by reference. Hydrogel formulations used in bead sequencing is discussed in US20220411859A1 incorporated herein in its entirety by reference. Examples of hydrogel used in spatial indexed and library preparation are discussed in US20220243269A1 incorporated herein in its entirety by reference. Some non-limiting examples of polymer coatings are described in WO2013184796A1 incorporated in its entirety herein by reference. Patterned gel surface are described in US20120316086A1 incorporated herein in its entirety by reference. Gel patterned surfaces are described in WO2014133905A1 incorporated herein in its entirety by reference. Surface activated polymers are described in U.S. Pat. No. 5,583,211A incorporated herein in its entirety by reference. Selective surface patterning is described in US20210010080A1 incorporated herein in its entirety by reference. Materials used for optically transmissible resins, films, and coatings are found in U.S. Pat. No. 9,880,102B2 incorporated herein in its entirety by reference.

### EXAMPLES

The following examples are intended to illustrate particular embodiments of the present disclosure but are by no means intended to limit the scope thereof.

Although some non-limiting examples have been depicted and described in detail herein, it will be apparent to those skilled in the relevant art that various modifications, additions, substitutions, and the like may be made without departing from the spirit of the present disclosure and these are therefore considered to be within the scope of the present disclosure as defined in the claims that follow.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein and may be used to achieve the benefits and advantages described herein.

FIG. 1 shows some non-limiting examples of roll to roll manufacturing of a flow cell substrate. A substrate 150 may comprise a flexible polymer film 110 with a layer of resin 120 which may contain depressions, such as nanowells, on the surface of predetermined depths 130 and widths 115 separated by interstices 125 which may be covered by a coating of hydrogel 105. In an embodiment polishing may remove hydrogel from the interstices 125 and may leave hydrogel in the depressions 130. In another embodiment polishing may remove hydrogel 105 from the interstices or interstitial region 125 and some of the hydrogel from the depressions 130. In another example, not shown, depressions such as nanowells may be present in a surface of a polymer film without a resin having depressions therein being present on the surface of the polymer film, and a hydrogel may be coated on the surface of the polymer film and its depressions such as nanowells and interstices therebetween.

FIG. 2 shows non-limiting examples of roll to roll manufacturing of a flow cell substrate where a substrate 265 may be unspooled from a source coil 200 onto a support 220 and, optionally, one or more slurry lines 210 may provide a slurry 215 on a surface of a substrate 265. A polishing pad 230 may rotate around an axis 235 extending along a y-plane. For illustrative purposes, an x-y-z coordinate axis system is illustrated for purposes of describing relative movement, orientation, and rotation of polishers and substrates as depicted throughout the present disclosure and represents such relative movement, not absolute movement, orientation, or rotation. Rotation of a polishing pad 230 about a y-axis 225 may introduce relative movement between the polishing pad 230 and the substrate 265. A substrate 265 also may move in a first direction 270, along an x-plane. In another embodiment one or more rollers 250 may be used to wash and clean the surface of the substrate 265 and a rinsing line 240 may provide rollers 250 rinse fluid 245 for rinsing. In another embodiment a device 260 may provide drying heat or drying air 255. In another embodiment the device 260 may rinse 255 the substrate. In another embodiment the device 260 may be used to monitor the surface of the substrate 265. In another embodiment a device 260 for each of washing, drying, rising, monitoring or any combination thereof may be present. In another embodiment a system 280 for polishing a substrate 265 is illustrated and may have any combination of coils 200, slurry lines 210, supports 220, polishing pads 230, polishing rollers 250 and devices 260 for washing, rinsing, drying or monitoring the substrate. An x-axis, y-axis and z-axis coordinate is provided for convenience in describing the relative directions of movement. Other vectors of movement may be present but may not be used to describe the general direction of movement to help illustrate a characteristic of a figure or a movement.

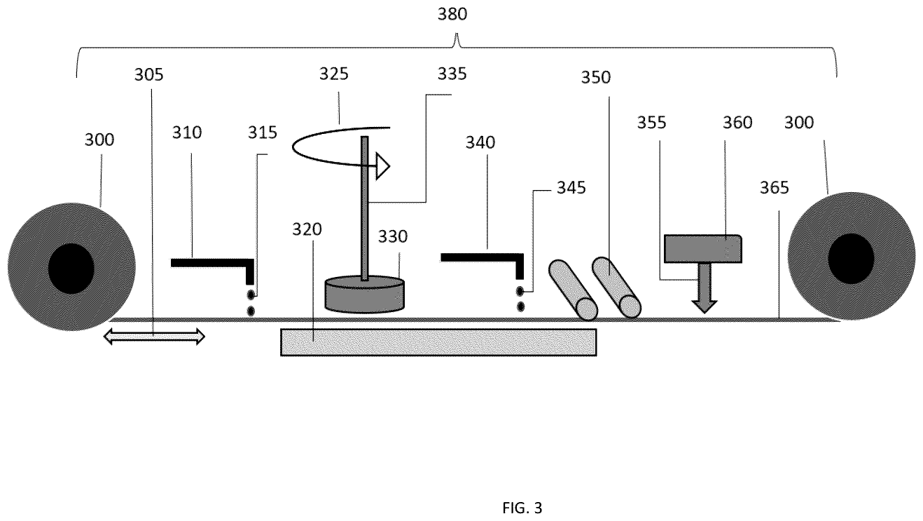

FIG. 3 shows non-limiting examples roll to roll manufacturing of a flow cell substrate. Source coils 300 may uncoil and coil the substrate 365. A slurry line 310 may provide a slurry 315 to the surface of a substrate 365. A support 320 may provide resistance or positive force to a polishing pad 330 which may rotate 325 about a y-axis 335 and may introduce relative motion between the polishing pad 330 and the substrate 365. In another embodiment the substrate 365 may move in a first direction 305 and a slurry line 310 may provide a slurry 315 to the surface of the substrate 365. A polishing pad 330 may polish a surface of the substrate and may remove a coating of hydrogel from the interstitial regions and not the depressions. Following polishing a substrate 365 may move in a first direction 305 to a wash line 340 that may provide a wash solution 345 and washing rollers 350 may work with the wash solution to clean the substrate. In an embodiment after washing a substrate 365 may continue in a direction 305 to a device 360 which may provide drying heat to dry the substrate. In another embodiment a substrate 365 may move in a first direction 305 and a slurry line 310 may provide a slurry 315 and a polishing pad 330 may rotate 325 about a y-axis 335 and may introduce relative movement between the polishing pad 330 and substrate 365 and may remove a some of the coating from a substrate 365. In an embodiment the substrate 365 may continue to a second slurry line 340 and a second slurry 345 may cover the substrate 365 and polishing roller 350 may polish the substrate after which a device 360 may wash and dry 355 the substrate 365 and may be and coiled on a coil 300. In another embodiment a system 380 is provided for polishing a substrate. The system may perform unspoooling the substrate 365 from a coil 300, may provide a slurry 315 from the slurry line 310, may polish with a polishing pad 330, polishing roller 350, polish belt, polishing blade or any combination and may wash, dry, monitor the substrate 365 with a device 360 while moving the substrate 365 in any direction 305 to perform each step or multiple steps or each process.

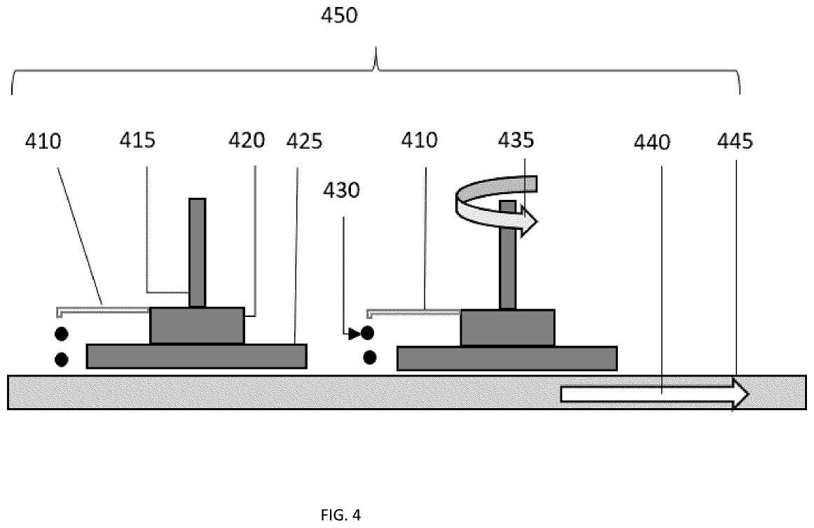

FIG. 4 shows a non-limiting example of polishing pads 425 with integrated slurry lines 410 that are attached to a housing 420 on the polishing pad 425 and may provide a slurry 430 to the substrate 445. The polish pad 425 may be attached to a shaft 415 which provides a rotation 435 which may introduce relative movement between the polishing pad 425 and the surface 445 which may be moving in a direction 440. In one embodiment a system 450 of polishing pads 425, slurry lines 410 and slurry 430 may work together to perform one aspect of polishing a substrate. In an example, during the polishing, one or more polishing pad, in addition to rotating around an axis, may also be displaced during the rotation, or between periods of rotation when rotation is not occurring, such as moving along an x-plane or z-plane or both.

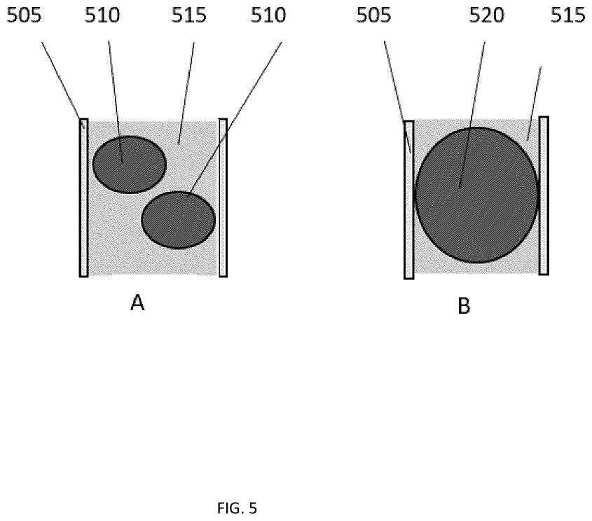

The left panel of FIG. 5 shows non-limiting examples of polishing pads 510 where the combined width of two pads may be as wide as the substrate 515. In another embodiment the slurry may be retained on the substrate 515 with the use of a trough 505 that retains the slurry on the substrate 515. The right panel of FIG. 5 shows non-limiting example of a polishing pad where the width of the polishing pad 520 may be substantially equal to the width of the substrate 515.

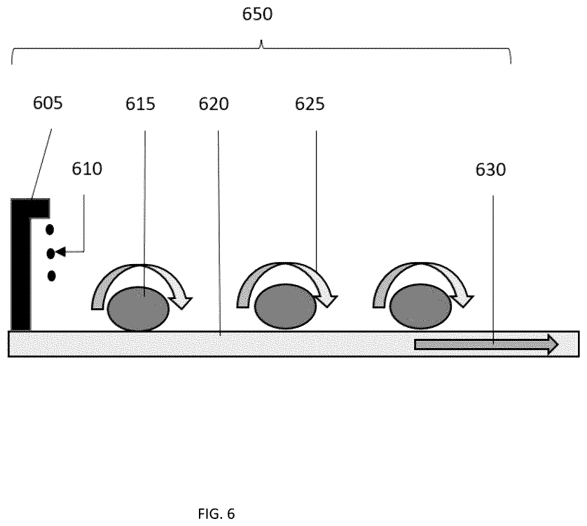

FIG. 6 shows non-limiting examples of polishing a substrate. A slurry line 605 may provide a slurry 610 on a substrate 620. which may move 630 along an x-plane to contact one or more polishing roller 615. Polishing rollers 615 may rotate 625 which may introduce relative movement between the polishing roller 615 and the surface 620. In an embodiment two or more of the one or more polishing rollers may rotate 625 in the same direction as each other (e.g., clockwise or counterclockwise), but it is to be understood they may rotate in different directions from each other, the same direction, alternating direction or any direction desired. In an embodiment a system of polishing rollers 650 may be a group of polishing rollers 615 with optional slurry lines 605 and slurry 610 that may operate to polish the substrate 620. In an example, during the polishing, one or more roller, in addition to rotating around an axis, may also be displaced during the rotation, or between periods of rotation when rotation is not occurring, such as moving along an x-plane or z-plane or both.

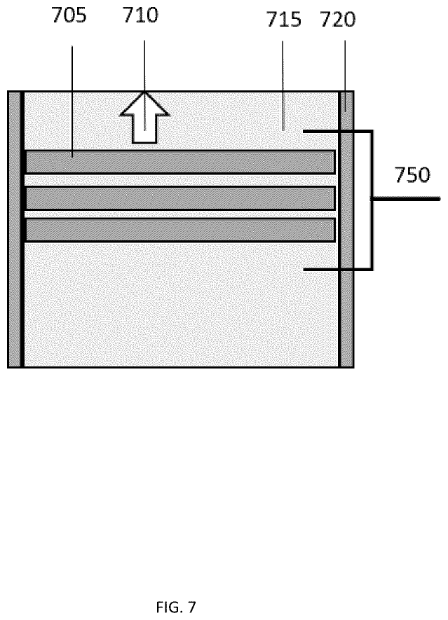

FIG. 7 shows a non-limiting example of an overhead view of polishing rollers 705 or a group of polishing rollers 750 that may polish a substrate 715 which may move in a direction 710 while being polished by the polishing rollers 705. A polisher may include two rollers. One or more roller may be wider than the substrate. One or more roller 705 may be approximately the same width as the substrate 715. A group of rollers 750 may be wider, narrower, approximately the same widths as the substrate 715 or any combination thereof. Two or more rollers may have a combined width approximately equal to the width of the substrate. A roller may be displaced in any of x-axis, z-axis, y-axis or any combination thereof whether polishing or not.

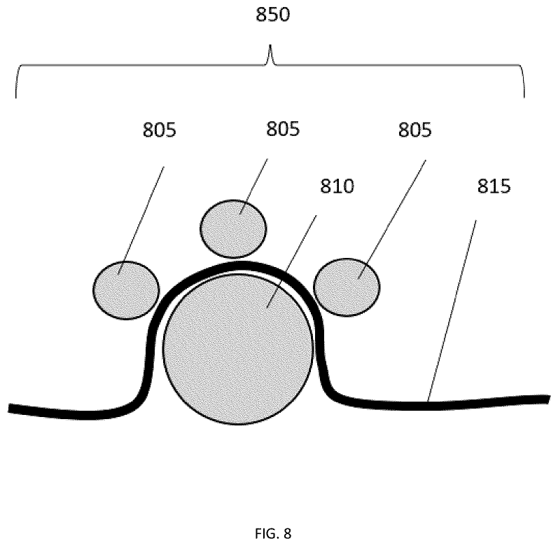

FIG. 8 shows non-limiting examples of polishing rollers 805 that may polish a substrate 815 that may partially wrap around and be supported on a cylindrical support 810. A system of polishing rollers 850 may include one or more cylindrical supports 810 for the substrate 815.

FIG. 9 shows a non-limiting example of a polishing belt 915 that may polish a substrate 910. In an embodiment, a polishing belt 915 may move in a direction 920 while the substrate may move in an opposite direction 905. In an embodiment a portion of a polishing belt 915 may be conditioned at a conditioning site 925, such as during polishing. A conditioning site, at a displacement from where a belt contacts a surface, may permit conditioning of a belt polisher without interruption of the polishing and prolong the polishing life of a belt polisher and render polishing and belt polisher maintenance more efficient by reducing downtime that would otherwise be necessary to condition a belt sander separately from when polishing occurs. The polishing belt 915 may move over a series of wheels 930 and may move in a direction 920 to introduce relative movement between the polishing belt 915 and the substrate 910. In an example, during the polishing, one or more belt, in addition to rotating around an axis, may also be displaced during the rotation, or between periods of rotation when rotation is not occurring, such as moving along an x-plane or z-plane or both.

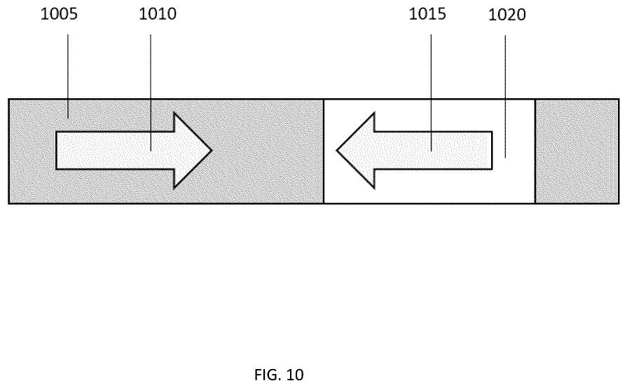

FIG. 10 shows a non-limiting example of the direction of movement of the substrate 1010 and the location of the polishing belt 1020 and the relative motion of the polishing belt 1015. In an embodiment the substrate 1005 may move in a direction 1010 and the polishing belt 1020 may move in a direction 1015 opposite to the substrate.

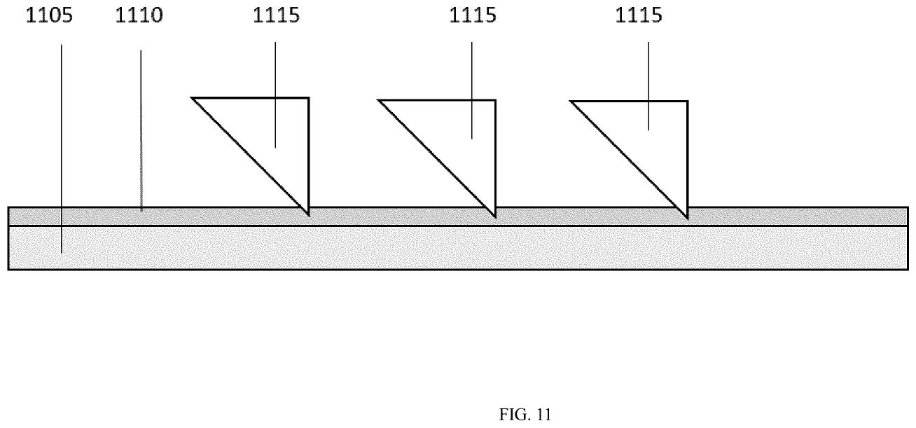

FIG. 11 shows a non-limiting example of blades 1115 polishing a substrate 1110 on a support 1105. In an embodiment the two or more blades 1115 may face different directions which may allow two or more blades to polishing the substrate 1110 while it moves in opposite directions. In another embodiment the angle of the blade may be configured between 0 and 180 degrees to polishing the substate.

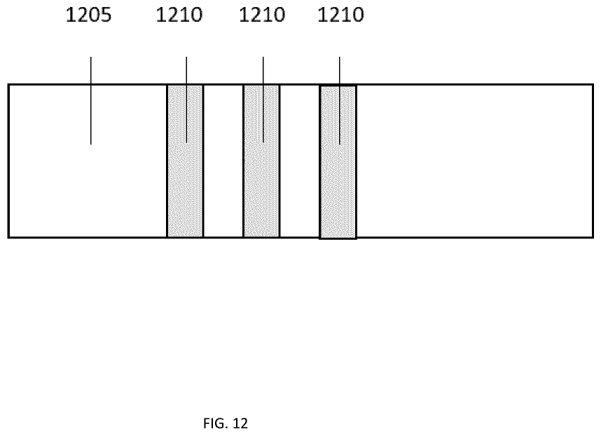

FIG. 12 shows a non-limiting example of an overhead view of blades 1210 polishing a substrate 1205.

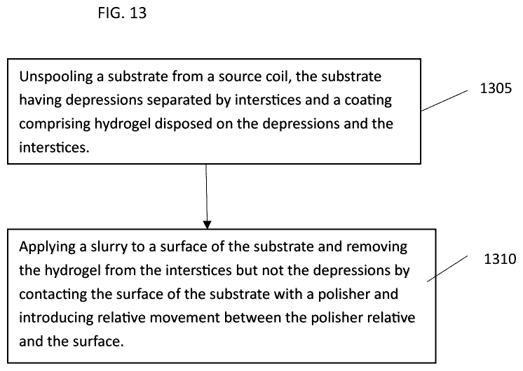

FIG. 13 shows a non-limiting example of a flow chart of roll to roll manufacturing of a flow cell. In an embodiment the method may begin with unspooling a substrate from a source coil, the substrate includes depressions separated with interstices which may be a flat area between depressions, and there may be a coating of hydrogel over the depressions and interstices 1305 then a slurry may be applied to a surface of the substrate and the hydrogel may be removed from the interstices but not the depression by contacting the surface of the substrate with a polisher and introducing relative movement between the polisher and the surface 1310. In an embodiment introducing relative movement between the polisher and the substrate may include moving the substrate in an x-axis while a polisher may remain stationary. In an embodiment introducing relative movement may include moving a substrate in an x-axis while a stationary belt may contact the substrate. In an embodiment introducing relative movement may include a substrate moving in an x-axis while a belt may rotate in an opposing direction. In an embodiment introducing relative movement may include moving a substrate in an x-axis while a belt may rotate in the same direction at a different speed.

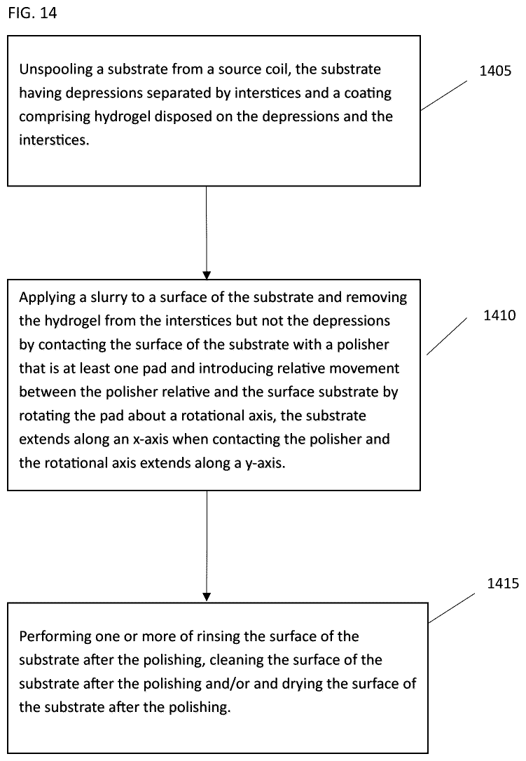

FIG. 14 shows a non-limiting example of a flow chart of roll to roll processing of a flow cell. In an embodiment a pad may polish the substrate by rotating about a y-axis while the substrate may extend along an x-axis and after polishing the substrate may be rinsed and dried.

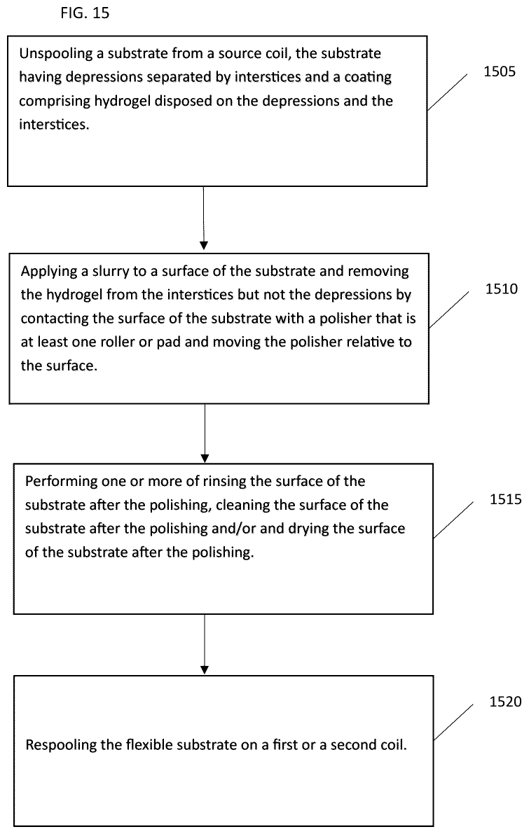

FIG. 15 shows a non-limiting example of a flow chart of roll to roll processing of a flow cell. In an embodiment a substrate may be unspooled from a source coil and a slurry may be applied and the surface may be polished to remove hydrogel from the interstices but not the depressions of the substrate. In an embodiment the substrate may be washed, dried and respooled on a second coil.

1. A method, comprising:
unspooling a substrate from a source coil and polishing a surface of the substrate, wherein
before the polishing, the substrate comprises depressions separated by interstices and a coating comprising a hydrogel disposed on the depressions and the interstices, and
the polishing comprises applying a slurry to the surface of the substrate and removing the hydrogel from the interstices but not the depressions by contacting the surface of the substrate with one or more polisher and introducing relative movement between the one or more polisher and the surface.

2. The method of claim 1, wherein the polishing comprises removing some of the hydrogel from the depressions.

3. The method of claim 1 wherein the polishing comprises removing substantially none of the hydrogel from the depressions.

4. The method of claim 1, wherein the introducing relative movement between the one or more polisher relative to the surface of the substrate comprises moving the substrate.

5. The method of claim 1, wherein the introducing relative movement between the polisher relative to the surface of the substrate comprises moving one or more of the one or more polisher.

6. The method of claim 1, wherein the depressions are in one surface of the substrate.

7. The method of claim 1, wherein the depressions are in both surfaces of the substrate.

8. The method of claim 1, wherein the substrate comprises a first surface and a second surface, a front of the first surface and a front of the second surface comprise the depressions, interstices, and coating, and a back of the first surface is laminated to a back of the second surface.

9. The method of claim 1, wherein the substrate further comprises a protective film.

10. The method of claim 1, further comprising disposing a protective film on the substrate.

11. The method of claim 1, wherein introducing relative movement comprises moving a first section of the substrate at a first speed while moving a second section of the substrate at a second speed.

12. The method of claim 1, further comprising accumulating one or more length of the substrate before a first polishing, after a first polishing and before a second polishing, after the polishing, and any combination thereof.

13. The method of claim 1, further comprising accumulating the substrate with one or more accumulator.

14. The method of claim 13, wherein the accumulator comprises one or more tensioner.

15. The method of claim 13, wherein the accumulator comprises one or more support.

16. The method of claim 13, wherein the one or more accumulator retains the substrate at one or more tensions.

17. The method of claim 13, wherein the one or more accumulator retains one or more fixed lengths of the substrate.

18. The method of claim 13, wherein the one or more accumulator retains one or more variable lengths of the substrate.

19. The method of claim 13, wherein the substrate enters the one or more accumulator at a first speed and exits the one or more accumulator at a second speed wherein the first speed is either faster than, slower than, or equal to the second speed.

20-154. (canceled)
